(19) United States
(12) Patent Application Publication
(10) Pub. No.: US 2023/0207813 A1
(43) Pub. Date: Jun. 29, 2023

(54) SLURRY COMPOSITION FOR FLEXIBLE ELECTRODE IN SECONDARY BATTERY

(71) Applicant: GRST International Limited, Hong Kong (CN)

(72) Inventors: Kam Piu Ho, Hong Kong (CN); Yingkai Jiang, Shenzhen (CN)

(21) Appl. No.: 17/925,607

(22) PCT Filed: Jun. 3, 2021
(86) PCT No.: PCT/CN2021/098036

§ 371 Date: Nov. 15, 2022

(30) Foreign Application Priority Data
Jun. 17, 2020 (WO) PCT/CN2020/096672
Aug. 19, 2020 (WO) PCT/CN2020/110065
Aug. 19, 2020 (WO) PCT/CN2020/110105
Sep. 25, 2020 (WO) PCT/CN2020/117615
Sep. 25, 2020 (WO) PCT/CN2020/117738
Sep. 25, 2020 (WO) PCT/CN2020/117767
Sep. 25, 2020 (WO) PCT/CN2020/117789
Dec. 25, 2020 (WO) PCT/CN2020/139555
Dec. 30, 2020 (WO) PCT/CN2020/141488

(51) Int. Cl. H01M 4/62; H01M 4/525; H01M 4/36; H01M 4/131

(52) U.S. Cl. CPC H01M 4/622; H01M 4/525; H01M 4/366; H01M 4/625; H01M 4/131

(57) ABSTRACT

Provided is a slurry composition that can be used in manufacturing an electrode of a lithium-ion battery. The slurry composition comprises a binder, a solvent, an electrode active material, and an additive. The additive can be a compound described by the general formula (1). The binder is a copolymer comprising of one or more hydrophilic structural units and one or more hydrophobic structural units. The addition of the additive improves electrode flexibility significantly. A method to produce electrodes using this slurry is also disclosed. In addition, battery cells containing the electrode prepared using the slurry composition disclosed herein exhibit exceptional electrochemical performance.

### CROSS-REFERENCE TO RELATED APPLICATIONS

This is a U.S. national stage application of the International Patent Application No. PCT/CN2021/098036, filed Jun. 3, 2021, which claims the benefit under 35 U.S.C. § 365(c) of International Patent Application No. PCT/CN2020/096672, filed Jun. 17, 2020, International Patent Application No. PCT/CN2020/110065, filed Aug. 19, 2020, International Patent Application No. PCT/CN2020/117615, filed Sep.25, 2020, International Patent Application No. PCT/CN2020/110105, filed Aug. 19, 2020, International Patent Application No. PCT/CN2020/117738, filed Sep. 25, 2020, International Patent Application No. PCT/CN2020/117767, filed Sep. 25, 2020, International Patent Application No. PCT/CN2020/117789, filed Sep. 25, 2020, International Patent Application No. PCT/CN2020/139555, filed Dec. 25, 2020 and International Patent Application No. PCT/CN2020/141488, filed Dec. 30, 2020, the content of all of which are incorporated herein by reference in their entireties.

### FIELD OF THE INVENTION

The present invention relates to the field of batteries. In particular, this invention relates to electrodes and electrode slurries for lithium-ion batteries.

### BACKGROUND OF THE INVENTION

Over the past decades, lithium-ion batteries (LIBs) have come to be widely utilized in various applications, especially consumer electronics, because of their outstanding energy density, long cycle life and high discharging capability. Due to rapid market development of electric vehicles (EV) and grid energy storage, high-performance, low-cost LIBs are currently one of the most promising options for large-scale energy storage devices.

Conventionally, lithium-ion battery electrodes are manufactured by coating an organic-based slurry onto a metallic current collector. The slurry contains electrode active material, conductive carbon, and binder in an organic solvent. The binder, most commonly polyvinylidene fluoride (PVDF), is dissolved in the solvent and provides good electrochemical stability, strong adhesion and high flexibility to the electrode materials and current collectors, such that the electrodes can be stacked and wound into a jelly-roll configuration to form a battery. However, PVDF can only dissolve in some specific organic solvents such as N-methyl-2-pyrrolidone (NMP) which is flammable and toxic and hence requires specific handling procedures. An NMP recovery system would have to be in place during the drying process to recover NMP vapors. This will generate significant costs in the manufacturing process since it requires a large capital investment. Moreover, NMP and PVDF can damage the environment.

In light of the above, the use of less expensive and more environmentally-friendly solvents, such as water, is preferred. However, in general, aqueous solvents present some difficulties to achieving good dispersion of binders and electrode active material particles. Poor dispersion leads to poor structural stability and flexibility in the resultant electrode, causing issues when winding into a jelly-roll configuration, such as breakage of the electrode.

Some water-based polymer binder formulations have been successfully applied to electrode production and can provide electrode slurries with good dispersion, i.e., a homogenous mixture without phase separation. However, the resulting electrodes are still highly inflexible and fragile if the electrode coating has a high density. This problem is most apparent when using electrode active materials with relatively low energy densities as they require more material to achieve the same output capacity, making their electrodes thicker and more inflexible.

When an electrode with insufficient flexibility is bent, stress concentration at the bending position leads to the exfoliation and fracture, which would further cause structural failure of the electrode. The performance and lifetime of the secondary battery would then be significantly degraded.

US Patent Application Publication No. 2020/002[[9]]8177 A1 discloses a lithium secondary battery cathode with a cathode active material layer comprising a cathode active material, a binder, graphene and carbon black. In particular, the density of the cathode active material layer should be greater than or equal to 4.3 g/cm³, and the cathode active material tested was LiCoO₂. The patent application discloses that a cathode with these characteristics do not break when wound and a battery with such a cathode has increased stability and cycle life. However, this prior art only successfully demonstrates that the above benefits are obtained when the binder is PVDF dissolved in NMP. Furthermore, the use of two carbon materials is essential and graphene cannot be substituted with more common forms of graphite, increasing costs significantly.

Therefore, there is a pressing need to devise a method to improve the flexibility of electrodes produced via a water-based process.

### SUMMARY OF THE INVENTION

The aforementioned needs are met by various aspects and embodiments disclosed herein. In one aspect, provided herein is a slurry for making an electrode for a secondary battery, the slurry comprising an electrode active material, a binder, an additive and a solvent.

In another aspect, provided herein is an electrode for a secondary battery, comprising a current collector and an electrode layer coated on one or more surfaces of the current collector, wherein the electrode layer comprises the above-mentioned electrode slurry. In some embodiments, the electrode layer comprises an electrode active material, a binder and an additive.

In yet another aspect, provided herein is a method of preparing the above-mentioned electrode slurry.

The additive is designed to provide flexibility to the resulting electrode. In particular, the addition of the additive can dramatically improve electrode flexibility when the solvent is water or an aqueous solution and an aqueous binder is used. Furthermore, it has been found that cylindrical secondary batteries with electrodes produced with an additive show improved electrochemical performance.

### BRIEF DESCRIPTION OF THE DRAWINGS

FIG. 1 is a flow chart illustrating the steps for preparing an electrode according to one embodiment of the present invention.

FIG. 2 is a photograph of the coating on the electrode of Example 1 of the present application.

FIG. 3 is a photograph of the coating on the electrode of Comparative Example 6 of the present application.

### DETAILED DESCRIPTION OF THE INVENTION

In one aspect, provided herein is a slurry for making an electrode for a secondary battery, the slurry comprising an electrode active material, a binder, an additive and a solvent. In another aspect, provided herein is an electrode for a secondary battery, comprising a current collector and an electrode layer coated on one or more surfaces of the current collector, wherein the electrode layer comprises the above-mentioned electrode slurry. In yet another aspect, provided herein is a method of preparing the above-mentioned electrode slurry.

The term “electrode” refers to a cathode or an anode.

The term “positive electrode” is used interchangeably with cathode. Likewise, the term “negative electrode” is used interchangeably with anode.

The term “binder” or “binder material” refers to a chemical compound, mixture of compounds, or polymer used to hold an electrode active material and/or a conductive agent in place and adhere them onto a conductive substrate to form an electrode. In some embodiments, the electrode does not comprise any conductive agent. In some embodiments, the binder forms a colloid, solution or dispersion in an aqueous solvent such as water.

The term “binder composition” refers to a colloid, dispersion or solution comprising the binder and a dispersion medium or solvent. In some embodiments, the dispersion medium or solvent is water.

The term “polymer” refers to a polymeric compound prepared by polymerizing monomers, whether of the same or a different type. The generic term “polymer” embraces the terms “homopolymer” as well as “copolymer.”

The term “homopolymer” refers to a polymer prepared by the polymerization of the same types of monomer. The term “copolymer” refers to a polymer prepared by the polymerization of at least two different types of monomers.

The term “aggregate weight of a repeating unit” refers to the total weight of all the repetitions of the repeating unit.

The term “monomeric unit” refers to the constitutional unit contributed by a single monomer to the structure of a polymer.

The term “structural unit” refers to the total monomeric units contributed by the same monomer type in a polymer.

The term “olefin” refers to an unsaturated hydrocarbon-based compound with at least one carbon-carbon double bond.

The term “hydrophilic” refers to a tendency to interact strongly, for example through the formation of hydrogen bonds, with polar solvents, especially water, or polar functional groups. Hydrophilic groups are usually themselves polar, and many compounds containing hydrophilic groups can dissolve in water. Some non-limiting examples of hydrophilic groups include carboxylic acid, hydroxyl, and amide.

The term “hydrophobic group” refers to a functional group that tends not to interact strongly, for example through the formation of hydrogen bonds, with polar solvents, especially water, or polar functional groups. Hydrophobic groups are usually non-polar, and compounds containing hydrophobic groups are usually not soluble in water.

The term “hydrophile-lipophile balance number” (HLB) of a chemical substance is defined mathematically as:

$$HLB = 20 \times \frac{{M}_{h}}{M}$$

where Mₕ is the molecular mass of the hydrophilic portions of the chemical substance and M is the total molecular mass of the chemical substance. The higher the HLB number, the more hydrophilic the chemical substance.

The term “hydroxyl value” refers, with respect to a chemical substance that contains free hydroxyl groups, to the number of milligrams of potassium hydroxide required to neutralize the acetic acid taken up on acetylation of one gram of that chemical substance. It is a measure of the content of free hydroxyl groups in a chemical substance. The higher the hydroxyl value, the more hydrophilic the chemical substance.

The term “conductive agent” refers to a material that has good electrical conductivity. Therefore, the conductive agent is often mixed with an electrode active material at the time of forming an electrode to improve electrical conductivity of the electrode. In some embodiments, the conductive agent is chemically active. In other embodiments, the conductive agent is chemically inactive.

The term “homogenizer” refers to an equipment that can be used for the homogenization of materials. The term “homogenization” refers to a process of distributing the materials uniformly throughout a fluid. Any conventional homogenizers can be used for the method disclosed herein. Some non-limiting examples of the homogenizer include stirring mixers, planetary mixers, blenders and ultrasonicators.

The term “planetary mixer” refers to an equipment that can be used to mix or stir different materials for producing a homogeneous mixture, which consists of blades conducting a planetary motion within a vessel. In some embodiments, the planetary mixer comprises at least one planetary blade and at least one high-speed dispersion blade. The planetary and the high-speed dispersion blades rotate on their own axes and also rotate continuously around the vessel. The rotation speed can be expressed in unit of rotations per minute (rpm) which refers to the number of rotations that a rotating body completes in one minute.

The term “ultrasonicator” refers to an equipment that can utilize ultrasound energy to agitate particles in a sample. Any ultrasonicator that can disperse the slurry disclosed herein can be used herein. Some non-limiting examples of the ultrasonicator include an ultrasonic bath, a probe-type ultrasonicator, and an ultrasonic flow cell.

The term “ultrasonic bath” refers to an apparatus through which the ultrasonic energy is transmitted via the container's wall of the ultrasonic bath into the liquid sample.

The term “probe-type ultrasonicator” refers to an ultrasonic probe immersed into a medium for direct sonication. The term “direct sonication” means that the ultrasound is directly coupled into the processing liquid.

The term “ultrasonic flow cell” or “ultrasonic reactor chamber” refers to an apparatus through which sonication processes can be carried out in a flow-through mode. In some embodiments, the ultrasonic flow cell is in a single-pass, multiple-pass or recirculating configuration.

The term “applying” refers to an act of laying or spreading a substance on a surface.

The term “current collector” refers to any conductive substrate, which is in contact with an electrode layer and is capable of conducting an electrical current flowing to electrodes during the discharging or charging a secondary battery. Some non-limiting examples of the current collector include a single conductive metal layer or substrate and a single conductive metal layer or substrate with an overlying conductive coating layer, such as a carbon black-based coating layer. The conductive metal layer or substrate may be in the form of a foil or a porous body having a three-dimensional network structure, and may be a polymeric or metallic material or a metalized polymer. In some embodiments, the three-dimensional porous current collector is covered with a conformal carbon layer.

The term “electrode layer” refers to a layer, which is in contact with a current collector, that comprises an electrochemically active material. In some embodiments, the electrode layer is made by applying a coating on to the current collector. In some embodiments, the electrode layer is located on one side or both sides of the current collector. In other embodiments, the three-dimensional porous current collector is coated conformally with an electrode layer.

The term “room temperature” refers to indoor temperatures from about 18° C. to about 30° C., e.g., 18, 19, 20, 21, 22, 23, 24, 25, 26, 27, 28, 29, or 30° C. In some embodiments, room temperature refers to a temperature of about 20° C. +/−1° C. or +/−2° C. or +/−3° C. In other embodiments, room temperature refers to a temperature of about 22° C. or about 25° C.

The term “particle size D50” refers to a volume-based accumulative 50% size (D50), which is a particle size at a point of 50% on an accumulative curve (i.e., a diameter of a particle in the 50th percentile (median) of the volumes of particles) when the accumulative curve is drawn so that a particle size distribution is obtained on the volume basis and the whole volume is 100%. Further, with respect to the electrode active material of the present invention, the particle size D50 means a volume-averaged particle size of secondary particles which can be formed by mutual agglomeration of primary particles, and in a case where the particles are composed of the primary particles only, it means a volume-averaged particle size of the primary particles.

The term “solid content” refers to the amount of non-volatile material remaining after evaporation.

The term “peeling strength” refers to the amount of force required to separate two materials that are adhered to each other, such as a current collector and an electrode layer. It is a measure of the adhesion strength between such two materials and is usually expressed in N/cm.

The term “C rate” refers to the charging or discharging rate of a cell or battery, expressed in terms of its total storage capacity in Ah or mAh. For example, a rate of 1 C means utilization of all of the stored energy in one hour; a 0.1 C means utilization of 10% of the energy in one hour or full energy in 10 hours; and a 5 C means utilization of full energy in 12 minutes.

The term “ampere-hour (Ah)” refers to a unit used in specifying the storage capacity of a battery. For example, a battery with 1 Ah capacity can supply a current of one ampere for one hour or 0.5 A for two hours, etc. Therefore, 1 ampere-hour (Ah) is the equivalent of 3,600 coulombs of electrical charge. Similarly, the term “milliampere-hour (mAh)” also refers to a unit of the storage capacity of a battery and is 1/1,000 of an ampere-hour.

The term “battery cycle life” refers to the number of complete charge/discharge cycles a battery can perform before its nominal capacity falls below 80% of its initial rated capacity.

The term “capacity” is a characteristic of an electrochemical cell that refers to the total amount of electrical charge an electrochemical cell, such as a battery, is able to hold. Capacity is typically expressed in units of ampere-hours. The term “specific capacity” refers to the output capacity of an electrochemical cell, such as a battery, per unit weight, usually expressed in Ah/kg or mAh/g.

In the following description, all numbers disclosed herein are approximate values, regardless whether the word “about” or “approximate” is used in connection therewith. They may vary by 1 percent, 2 percent, 5 percent, or, sometimes, 10 to 20 percent. Whenever a numerical range with a lower limit, R^{L}, and an upper limit, R^{U}, is disclosed, any number falling within the range is specifically disclosed. In particular, the following numbers within the range are specifically disclosed: , R=R^{L}+k*(R^{U}−RL^{L}), wherein k is a variable ranging from 0 percent to 100 percent inclusive. Moreover, any numerical range defined by two R numbers as defined above is also specifically disclosed.

In the present description, all references to the singular include references to the plural and vice versa.

In one aspect, the present invention provides a slurry for making an electrode for a secondary battery, the slurry comprising an electrode active material, a binder, an additive and a solvent. Electrodes made from the electrode slurry disclosed herein show dramatically improved flexibility, and remain smooth and wrinkle free even at high surface density and high compacted density. Batteries comprising these electrodes have improved electrochemical performance as well.

The additive allows the electrode to be softer and more flexible by embedding itself between polymer chains in the binder and increasing the distance between the chains. This in turn increases the mobility of the molecules within the polymer chains. By increasing the distance between binder polymer chains, the intermolecular forces between polymer chains within the binder are also decreased. In addition, the additive molecules may also electrostatically interact with the polymer chains themselves, decreasing the effective interactive forces between polymer chains through the added effect of interactions with the additive interactions. The overall result is increased flexibility of the binder. This effect is particularly pronounced for aqueous binders as they contain hydrophilic groups that allow strong interactions between the polymer chains of the binders through the formation of hydrogen bonds and other polar interactions.

In some embodiments, the additive is a polymer represented by the following general formula (1).

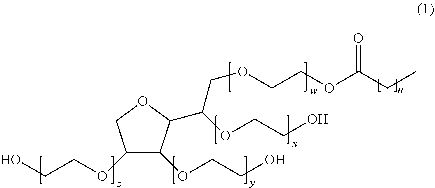

Additives represented by general formula (1) contain five repeating units, which are repeated n, w, x, y and z times respectively.

In some embodiments, the value of n is from about 5 to about 25, from about 8 to about 25, from about 10 to about 25, from about 12 to about 25, from about 15 to about 25, from about 5 to about 22, from about 8 to about 22, from about 10 to about 22, from about 12 to about 22, from about 5 to about 20, from about 8 to about 20, from about 10 to about 20, from about 10 to about 18, from about 10 to about 17, from about 10 to about 16, or from about 12 to about 20. In certain embodiments, the value of n is 5, 6, 7, 8, 9, 10, 11, 12, 13, 14, 15, 16, 17, 18, 19, 20, 21, 22, 23, 24 or 25.

In some embodiments, the value of n is about 25 or lower, about 22 or lower, about 20 or lower, about 18 or lower, about 15 or lower, about 12 or lower, or about 10 or lower. In some embodiments, the value of n is about 5 or higher, about 8 or higher, about 10 or higher, about 12 or higher, or about 15 or higher.

In some embodiments, the values of w, x, y and z are each independently from about 1 to about 50, from about 5 to about 50, from about 10 to about 50, from about 20 to about 50, from about 30 to about 50, from about 1 to about 40, from about 5 to about 40, from about 10 to about 40, from about 20 to about 40, from about 1 to about 30, from about 5 to about 30, from about 10 to about 30, from about 15 to about 30, from about 1 to about 20, from about 5 to about 20, from about 10 to about 20, from about 15 to about 20, from about 1 to about 15, from about 5 to about 15, from about 10 to about 15, from about 1 to about 10, or from about 5 to about 10. In certain embodiments, the values of w, x, y and z are each independently 1, 2, 3, 4, 5, 6, 7, 8, 9, 10, 11, 12, 13, 14, 15, 16, 17, 18, 19 or 20.

In some embodiments, the sum of w, x, y and z is from about 4 to about 80, from about 8 to about 80, from about 10 to about 80, from about 15 to about 80, from about 20 to about 80, from about 25 to about 80, from about 30 to about 80, from about 40 to about 80, from about 50 to about 80, from about 60 to about 80, from about 40 to about 70, from about 50 to about 70, from about 4 to about 60, from about 8 to about 60, from about 10 to about 60, from about 15 to about 60, from about 20 to about 60, from about 25 to about 60, from about 30 to about 60, from about 40 to about 60, from about 4 to about 40, from about 8 to about 40, from about 10 to about 40, from about 15 to about 40, from about 20 to about 40, from about 25 to about 40, from about 4 to about 35, from about 8 to about 35, from about 10 to about 35, from about 15 to about 35, from about 20 to about 35, from about 4 to about 30, from about 8 to about 30, from about 10 to about 30, from about 15 to about 30, from about 20 to about 30, from about 4 to about 25, from about 8 to about 25, from about 10 to about 25, from about 15 to about 25, or from about 20 to about 25. In certain embodiments, the sum of w, x, y and z is 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40.

In some embodiments, the sum of w, x, y and z is about 80 or less, about 60 or less, about 40 or less, about 35 or less, about 30 or less, about 25 or less, or about 20 or less. In some embodiments, the sum of w, x, y and z is about 4 or more, about 8 or more, about 10 or more, about 15 or more, about 20 or more, about 25 or more, about 30 or more, about 35 or more, about 40 or more, or about 60 or more.

In some embodiments, the hydroxyl value of the additive represented by the general formula (1) is from about 65 to about 110, from about 67 to about 110, from about 69 to about 110, from about 71 to about 110, from about 73 to about 110, from about 75 to about 110, from about 77 to about 110, from about 79 to about 110, from about 81 to about 110, from about 83 to about 110, from about 85 to about 110, from about 85 to about 108, from about 85 to about 106, from about 85 to about 104, from about 85 to about 102, from about 85 to about 100, from about 85 to about 98, from about 85 to about 96, from about 85 to about 94, from about 85 to about 92, or from about 85 to about 90.

In some embodiments, the hydroxyl value of the additive represented by the general formula (1) is less than 110, less than 108, less than 106, less than 104, less than 102, less than 100, less than 98, less than 96, less than 94, less than 92, less than 90, less than 88, less than 86, less than 84, less than 82, or less than 80. In some embodiments, the hydroxyl value of the additive represented by the general formula (1) is more than 65, more than 67, more than 69, more than 71, more than 73, more than 75, more than 77, more than 79, more than 81, more than 83, more than 85, more than 87, more than 89, more than 91, more than 93, or more than 95.

In some embodiments, the hydrophile-lipophile balance number of the additive represented by general formula (1) is from about 12 to about 18, from about 12.5 to about 18, from about 13 to about 18, from about 13.5 to about 18, from about 14 to about 18, from about 14.5 to about 18, from about 15 to about 18, from about 12 to about 17.5, from about 12.5 to about 17.5, from about 13 to about 17.5, from about 13.5 to about 17.5, from about 14 to about 17.5, from about 14.5 to about 17.5, from about 15 to about 17.5, from about 12 to about 17, from about 12.5 to about 17, from about 13 to about 17, from about 13.5 to about 17, from about 14 to about 17, from about 12 to about 16.5, from about 12.5 to about 16.5, from about 13 to about 16.5, from about 13.5 to about 16.5, from about 14 to about 16.5, from about 12 to about 16, from about 12.5 to about 16, from about 13 to about 16, from about 13.5 to about 16, from about 14 to about 16, from about 12 to about 15.5, from about 12.5 to about 15.5, from about 13 to about 15.5, from about 13.5 to about 15.5, from about 12 to about 15, from about 12.5 to about 15, or from about 13 to about 15.

In some embodiments, the hydrophile-lipophile balance number of the additive represented by general formula (1) is about 18 or lower, about 17.5 or lower, about 17 or lower, about 16.5 or lower, about 16 or lower, about 15.5 or lower, or about 15 or lower. In certain embodiments, the hydrophile-lipophile balance number of the additive represented by general formula (1) is about 12 or higher, about 12.5 or higher, about 13 or higher, about 13.5 or higher, about 14 or higher, about 14.5 or higher, or about 15 or higher.

Control of the values of w, x, y and z in general formula (1) is particularly critical. If the values are too small, it may lead to ineffective additive performance due to insufficient interactive behavior with the binder polymer. Conversely, values that are very high would also lead to decreased performance due to increased probability of bridging, resulting in increased net interactions between different polymer chains of the binder, rather than the desired decrease.

Similarly, control of the length of carbon chain n in general formula (1) is also critical, as having too low of a carbon chain length may lead to ineffective additive performance due to insufficient increasing of the distance between polymer chains. Conversely, having too high of a carbon chain length would also lead to decreased performance due to increased probability of physical entanglement and/or chemical interaction between different additive molecules, or between an additive molecule and multiple polymer chains.

In some embodiments, the proportion of the additive in the electrode slurry is from about 0.1% to about 5%, from about 0.2% to about 5%, from about 0.5% to about 5%, from about 0.8% to about 5%, from about 1% to about 5%, from about 1.2% to about 5%, from about 1.5% to about 5%, from about 1.8% to about 5%, from about 2% to about 5%, from about 2.2% to about 5%, from about 2.5% to about 5%, from about 0.1% to about 4.5%, from about 0.2% to about 4.5%, from about 0.5% to about 4.5%, from about 0.8% to about 4.5%, from about 1% to about 4.5%, from about 1.2% to about 4.5%, from about 1.5% to about 4.5%, from about 1.8% to about 4.5%, from about 2% to about 4.5%, from about 0.1% to about 4%, from about 0.2% to about 4%, from about 0.5% to about 4%, from about 0.8% to about 4%, from about 1% to about 4%, from about 1.2% to about 4%, from about 1.5% to about 4%, from about 1.8% to about 4%, from about 2% to about 4%, from about 0.1% to about 3.5%, from about 0.2% to about 3.5%, from about 0.5% to about 3.5%, from about 0.8% to about 3.5%, from about 1% to about 3.5%, from about 1.2% to about 3.5%, from about 1.5% to about 3.5%, from about 0.1% to about 3%, from about 0.2% to about 3%, from about 0.5% to about 3%, from about 0.8% to about 3%, from about 1% to about 3%, from about 0.5% to about 2%, or from about 0.5% to about 1.5% by weight, based on the total weight of the solid content of the electrode slurry.

In some embodiments, the proportion of the additive in the electrode slurry is about 5% or less, about 4.5% or less, about 4% or less, about 3.5% or less, or about 3% or less by weight, based on total weight of the solid content of the electrode slurry. In some embodiments, the proportion of the additive in the electrode slurry is about 0.1% or more, about 0.2% or more, about 0.3% or more, about 0.4% or more, about 0.5% or more, about 0.6% or more, about 0.7% or more, about 0.8% or more, about 0.9% or more, about 1% or more, about 1.1% or more, about 1.2% or more, about 1.3% or more, about 1.4% or more, or about 1.5% or more by weight, based on the total weight of the solid content of the electrode slurry.

In some embodiments, more than one additive may be used in the electrode slurry. In other embodiments, the electrode slurry only contains one additive.

In some embodiments, the binder comprises a copolymer. In some embodiments, the copolymer comprises one or more hydrophilic structural units, and one or more hydrophobic structural units.

In some embodiments, the one or more hydrophilic structural units are derived from a carboxylic acid-containing monomer. In some embodiments, the carboxylic acid-containing monomer is selected from the group consisting of acrylic acid, methacrylic acid, crotonic acid, isocrotonic acid, 2-butyl crotonic acid, cinnamic acid, maleic acid, fumaric acid, itaconic acid, tetraconic acid, angelic acid, tiglic acid, 2-pentenoic acid, 2-hexenoic acid, 2-heptenoic acid, 2-octenoic acid, 2-nonenoic acid, 2-decenoic acid, isomers thereof, and combinations thereof.

The carboxylic acid-containing monomer may optionally have one or more substituents. In certain embodiments, the one or more substituents is selected from the group consisting of C₁-C₆ alkyl, Ci-C6 alkoxy, hydroxyl, halogen, phenyl, amino, carbonyl, and combinations thereof. Some non-limiting examples of substituted carboxylic acid-containing monomers include 2-ethylacrylic acid, 3,3-dimethyl acrylic acid, 3-propyl acrylic acid, 2-methyl-3-ethyl acrylic acid, 3-isopropyl acrylic acid, 3-methyl-3-ethyl acrylic acid, 2-isopropyl acrylic acid, trimethyl acrylic acid, 2-methyl-3,3-diethyl acrylic acid, 3-butyl acrylic acid, 2-butyl acrylic acid, 2-pentyl acrylic acid, α-acetoxyacrylic acid, β-trans-aryloxyacrylic acid, α-chloro-β-(E)-methoxyacrylic acid and combinations thereof.

In some embodiments, the carboxylic acid-containing monomer is selected from the group consisting of methyl maleic acid, dimethyl maleic acid, phenyl maleic acid, bromo maleic acid, chloromaleic acid, dichloromaleic acid, fluoromaleic acid, difluoro maleic acid, nonyl hydrogen maleate, decyl hydrogen maleate, dodecyl hydrogen maleate, octadecyl hydrogen maleate, fluoroalkyl hydrogen maleate or a combination thereof. In some embodiments, the one or more hydrophilic structural units are not derived from a carboxylic acid-containing monomer.

In some embodiments, the carboxylic acid-containing monomer is in the form of a carboxylic acid, a carboxylic acid salt, a carboxylic acid derivative or a combination thereof. In some embodiments, the carboxylic acid salt and the carboxylic acid derivative can respectively be a salt or a derivative of a carboxylic acid listed above. In certain embodiments, the carboxylic acid derivative is selected from the group consisting of maleic anhydride, methyl maleic anhydride, dimethyl maleic anhydride, acrylic anhydride, methacrylic anhydride, methacrolein, methacryloyl chloride, methacryloyl fluoride, methacryloyl bromide, and combinations thereof. In some embodiments, the carboxylic acid-containing monomer is not present in the form of a carboxylic acid salt or a carboxylic acid derivative.

In some embodiments, the carboxylic acid salt comprises a metal cation. In certain embodiments, the metal cation is selected from the group consisting of Li, Na, K, Mg, Ca, Al, Fe, Zn, Cu and combinations thereof. In some embodiments, the carboxylic acid salt does not comprise a metal cation. In some embodiments, the carboxylic acid salt comprises an ammonium cation.

In some embodiments, the one or more hydrophilic structural units are derived from a hydroxyl-containing monomer. In some embodiments, the hydroxyl-containing monomer is an acrylate or methacrylate compound comprising a hydroxyl group. In some embodiments, the hydroxyl-containing monomer is selected from the group consisting of 2-hydroxyethylacrylate, 2-hydroxyethyl methacrylate, 2-hydroxypropyl acrylate, 2-hydroxypropyl methacrylate, 2-hydroxybutyl methacrylate, 3-hydroxypropylacrylate, 3-hydroxypropylmethacrylate, 4-hydroxybutyl methacrylate, 5-hydroxypentylacrylate, 6-hydroxyhexyl methacrylate, 1,4-cyclohexanedimethanol monomethacrylate, 1,4-cyclohexanedimethanol monoacrylate, 3-chloro-2-hydroxypropyl methacrylate, diethylene glycol monomethacrylate, diethylene glycol monoacrylate, and combinations thereof. In some embodiments, the hydroxyl-containing monomer is an alcohol. In certain embodiments, the hydroxyl-containing monomer is selected from the group consisting of vinyl alcohol, allyl alcohol, crotyl alcohol, isomers thereof, and combinations thereof. In some embodiments, the one or more hydrophilic structural units are not derived from a hydroxyl-containing monomer.

In some embodiments, the one or more hydrophilic structural units are derived from an amide-containing monomer. In some embodiments, the amide-containing monomer is selected from the group consisting of acrylamide, methacrylamide, N-methyl methacrylamide, N-ethyl methacrylamide, N-n-propyl methacrylamide, N-isopropyl methacrylamide, isopropyl acrylamide, N-n-butyl methacrylamide, N-isobutyl methacrylamide, N,N-dimethyl acrylamide, N,N-dimethyl methacrylamide, N,N-diethyl acrylamide, N,N-diethyl methacrylamide, N-methylol methacrylamide, N-(methoxymethyl)methacrylamide, N-(ethoxymethyl)methacrylamide, N-(propoxymethyl)methacrylamide, N-(butoxymethyl)methacrylamide, N,N-dimethylaminopropyl methacrylamide, N,N-dimethylaminoethyl methacrylamide, N,N-dimethylol methacrylamide, diacetone methacrylamide, diacetone acrylamide, methacryloyl morpholine, N-hydroxyl methacrylamide, N-methoxymethyl acrylamide, N-methoxymethyl methacrylamide, N,N′-methylene-bis-acrylamide, N-hydroxymethyl acrylamide, isomers thereof, and combinations thereof.

The amide-containing monomer may optionally have one or more substituents. In certain embodiments, the one or more substituents is selected from the group consisting of C₁-C₆ alkyl, C₁-C₆ alkoxy, hydroxyl, halogen, phenyl, amino, carbonyl, and combinations thereof. In some embodiments, the one or more hydrophilic structural units are not derived from an amide-containing monomer.

In some embodiments, the one or more hydrophobic structural units are derived from a nitrile-containing monomer. In some embodiments, the nitrile-containing monomer comprises an α,β-ethylenically unsaturated nitrile monomer. In some embodiments, the nitrile-containing monomer is selected from the group consisting of acrylonitrile, α-halogenoacrylonitrile, α-alkylacrylonitrile and combinations thereof. In some embodiments, the nitrile-containing monomer is selected from the group consisting of α-chloroacrylonitrile, α-bromoacrylonitrile, α-fluoroacrylonitrile, methacrylonitrile, α-ethylacrylonitrile, α-isopropylacrylonitrile, α-n-hexylacrylonitrile, α-methoxyacrylonitrile, 3-methoxyacrylonitrile, 3-ethoxyacrylonitrile, α-acetoxyacrylonitrile, α-phenylacrylonitrile, α-tolylacrylonitrile, α-(methoxyphenyl)acrylonitrile, α-(chlorophenyl)acrylonitrile, α-(cyanophenyl)acrylonitrile, vinylidene cyanide, isomers thereof, and combinations thereof.

The nitrile-containing monomer may optionally have one or more substituents. In certain embodiments, the one or more substituents is selected from the group consisting of C₁-C₆ alkyl, C₁-C₆ alkoxy, hydroxyl, halogen, phenyl, amino, carbonyl, and combinations thereof. In some embodiments, the one or more hydrophobic structural units are not derived from a nitrile-containing monomer.

In other embodiments, the one or more hydrophobic structural units are derived from an olefin monomer. In some embodiments, the olefin is selected from the group consisting of styrene, ethylene, propylene, isobutylene, butene, pentene, hexene, heptene, octene, nonene, decene, dodecene, tetradecene, hexadecene, octadecene, eicosene, isomers thereof, and combinations thereof. In certain embodiments, the olefin is selected from the group consisting of 3-methyl-1-butene, 3-methyl-1-pentene, 4-methyl-1-pentene, 4,6-dimethyl-1-heptene, 4-vinylcyclohexene, vinylcyclohexane, norbornadiene, ethylidene norbornene, cyclopentene, cyclohexene, dicyclopentadiene, cyclooctene, and combinations thereof. In some embodiments, an olefin is propylene, butene, pentene, hexene, octene or a combination thereof.

In some embodiments, the olefin is a conjugated diene. In some embodiments, the conjugated diene is a C₄-C₄₀ diene. In certain embodiments, the conjugated diene is an aliphatic conjugated diene. In certain embodiments, the aliphatic conjugated diene is selected from the group consisting of 1,3-butadiene, 1,3-pentadiene, 1,4-hexadiene, 1,5-hexadiene, 1,7-octadiene, 1,9-decadiene, isoprene, myrcene, 2-methyl-1,3-butadiene, 2,3-dimethyl-1,3-butadiene, 2-chloro-1,3-butadiene, substituted linear conjugated pentadienes, substituted branched conjugated hexadienes, and combinations thereof.

The olefin monomer may optionally have one or more substituents. In certain embodiments, the one or more substituents is selected from the group consisting of C₁-C₆ alkyl, C₁-C₆ alkoxy, hydroxyl, halogen, phenyl, amino, carbonyl, and combinations thereof. In other embodiments, the one or more hydrophobic structural units are not derived from an olefin monomer.

In other embodiments, the one or more hydrophobic structural units are derived from a monomer containing an aromatic vinyl group. In some embodiments, the monomer containing an aromatic vinyl group is selected from the group consisting of styrene, α-methylstyrene, vinyltoluene, divinylbenzene and combinations thereof. In other embodiments, the one or more hydrophobic structural units are not derived from a monomer containing an aromatic vinyl group.

In other embodiments, the one or more hydrophobic structural units are derived from ester-containing monomers. In some embodiments, the ester-containing monomer is a C₁-C₂₀ alkyl acrylate, a C₁-C₂₀ alkyl methacrylate, a cycloalkyl acrylate or a combination thereof. In some embodiments, the ester-containing monomer is selected from the group consisting of methyl acrylate, ethyl acrylate, n-propyl acrylate, isopropyl acrylate, n-butyl acrylate, sec-butyl acrylate, tert-butyl acrylate, pentyl acrylate, hexyl acrylate, heptyl acrylate, octyl acrylate, 3,3,5-trimethylhexyl acrylate, 2-ethylhexyl acrylate, nonyl acrylate, decyl acrylate, lauryl acrylate, n-tetradecyl acrylate, octadecyl acrylate, cyclohexyl acrylate, phenyl acrylate, methoxymethyl acrylate, methoxyethyl acrylate, ethoxymethyl acrylate, ethoxyethyl acrylate, perfluorooctyl acrylate, stearyl acrylate and combinations thereof. In some embodiments, the ester-containing monomer is cyclohexyl acrylate, cyclohexyl methacrylate, isobornyl acrylate, isobornyl methacrylate, 3,3,5-trimethylcyclohexylacrylate, or a combination thereof. In some embodiments, the ester-containing monomer is selected from the group consisting of methyl methacrylate, ethyl methacrylate, n-propyl methacrylate, isopropyl methacrylate, n-butyl methacrylate, sec-butyl methacrylate, tert-butyl methacrylate, isobutyl methacrylate, n-pentyl methacrylate, isopentyl methacrylate, hexyl methacrylate, heptyl methacrylate, octyl methacrylate, 2-ethylhexyl methacrylate, nonyl methacrylate, decyl methacrylate, lauryl methacrylate, n-tetradecyl methacrylate, stearyl methacrylate, 2,2,2-trifluoroethyl methacrylate, phenyl methacrylate, benzyl methacrylate, and combinations thereof. In other embodiments, the one or more hydrophobic structural units are not derived from ester-containing monomers.

In some embodiments, the binder may contain structural units derived from monomers with one or more functional groups comprising a halogen, O, N, S or a combination thereof. Some non-limiting examples of such functional groups include alkoxy, aryloxy, nitro, thiol, thioether, imine, cyano, amide, amino (primary, secondary or tertiary), carboxyl, ketone, aldehyde, ester, hydroxyl and a combination thereof. In some embodiments, the functional group is or comprises alkoxy, aryloxy, carboxy (i.e., —COOH), nitrile, —COOCH3, —CONH₂, —OCH₂CONH₂, or —NH₂. In certain embodiments, the binder material may contain structural units derived from one or more optionally substituted monomers selected from the group consisting of styrene, vinyl halides, vinyl pyridine, vinylidene fluoride, vinyl ether, vinyl acetate, acrylonitrile, acrylamide, methacrylamide, acrylic acid, methacrylic acid, acrylic ester, methacrylic ester, 2-hydroxyethyl acrylate and combinations thereof. In some embodiments, the binder does not contain structural units derived from monomers with functional groups comprising a halogen, O, N, S or a combination thereof.

In some embodiments, the binder is a random copolymer. In other embodiments, the binder material is a random copolymer wherein at least two monomer units are randomly distributed. In some embodiments, the binder material is an alternating copolymer. In other embodiments, the binder material is an alternating copolymer wherein the at least two monomer units are alternatively distributed. In certain embodiments, the binder material is a block copolymer.

In some embodiments, the proportion of all hydrophilic structural units within the binder is from about 10% to about 90%, from about 10% to about 85%, from about 10% to about 80%, from about 15% to about 80%, from about 15% to about 75%, from about 15% to about 70%, from about 20% to about 85%, from about 25% to about 85%, from about 30% to about 85%, from about 35% to about 85%, from about 40% to about 85%, from about 45% to about 85%, from about 50% to about 85%, from about 50% to about 80%, from about 50% to about 75%, from about 50% to about 70%, from about 50% to about 65%, from about 50% to about 60%, or from about 50% to about 55% by mole, based on the total number of moles of monomeric units in the binder. In some embodiments, the proportion of all hydrophilic structural units within the binder polymer is about 90% or less, about 85% or less, about 80% or less, about 75% or less, about 70% or less, about 65% or less, about 60% or less, about 55% or less, about 50% or less, about 45% or less, about 40% or less, about 35% or less, or about 30% or less by mole, based on the total number of moles of monomeric units in the binder. In some embodiments, the proportion of all hydrophilic structural units within the binder polymer is about 10% or more, about 12.5% or more, about 15% or more, about 20% or more, about 25% or more, about 30% or more, about 35% or more, about 40% or more, about 45% or more, about 50% or more, about 55% or more, about 60% or more, about 65% or more, about 70% or more, or about 75% or more by mole, based on the total number of moles of monomeric units in the binder.

In some embodiments, the proportion of all hydrophobic structural units within the binder is from about 5% to about 90%, from about 10% to about 90%, from about 10% to about 85%, from about 10% to about 80%, from about 10% to about 50%, from about 10% to about 35%, from about 10% to about 30%, from about 10% to about 25%, from about 15% to about 50%, from about 15% to about 35%, from about 15% to about 30%, or from about 15% to about 25% by mole, based on the total number of moles of monomeric units in the binder. In some embodiments, the proportion of all hydrophobic structural units within the binder polymer is about 90% or less, about 85% or less, about 80% or less, about 75% or less, about 70% or less, about 65% or less, about 60% or less, about 55% or less, about 50% or less, about 45% or less, about 40% or less, about 35% or less, or about 30% or less by mole, based on the total number of moles of monomeric units in the binder. In some embodiments, the proportion of all hydrophobic structural units within the binder polymer is about 10% or more, about 20% or more, about 25% or more, about 30% or more, about 35% or more, about 40% or more, about 45% or more, about 50% or more, about 55% or more, about 60% or more, about 65% or more, about 70% or more, or about 75% or more by mole, based on the total number of moles of monomeric units in the binder.

In some embodiments, the proportion of the one or more structural units derived from the carboxylic acid-containing monomer is from about 15% to about 85%, from about 15% to about 80%, from about 15% to about 75%, from about 15% to about 70%, from about 15% to about 65%, from about 15% to about 60%, from about 15% to about 55%, from about 15% to about 50%, from about 20% to about 85%, from about 20% to about 80%, from about 20% to about 75%, from about 20% to about 70%, from about 20% to about 65%, from about 20% to about 60%, from about 20% to about 55%, from about 20% to about 50%, from about 25% to about 85%, from about 25% to about 80%, from about 25% to about 75%, from about 25% to about 70%, from about 25% to about 65%, from about 25% to about 60%, from about 25% to about 55%, from about 25% to about 50%, from about 30% to about 85%, from about 30% to about 80%, from about 30% to about 75%, from about 30% to about 70%, from about 30% to about 65%, from about 30% to about 60%, from about 35% to about 85%, from about 35% to about 80%, from about 35% to about 75%, from about 35% to about 70%, from about 35% to about 65%, from about 35% to about 60%, from about 40% to about 85%, from about 40% to about 80%, from about 40% to about 75%, from about 40% to about 70%, from about 45% to about 85%, from about 45% to about 80%, from about 45% to about 75%, from about 45% to about 70%, from about 50% to about 85%, from about 50% to about 80%, from about 50% to about 75%, or from about 50% to about 70% by mole, based on the total number of moles of monomeric units in the binder.

In some embodiments, the proportion of the one or more structural units derived from the carboxylic acid-containing monomer is about 85% or lower, about 80% or lower, about 75% or lower, about 70% or lower, about 69% or lower, about 68% or lower, about 67% or lower, about 66% or lower, about 65% or lower, about 64% or lower, about 63% or lower, about 62% or lower, about 61% or lower, about 60% or lower, about 59% or lower, about 58% or lower, about 57% or lower, about 56% or lower, about 55% or lower, about 54% or lower, about 53% or lower, about 52% or lower, about 51% or lower, or about 50% or lower by mole, based on the total number of moles of monomeric units in the binder. In some embodiments, the proportion of the one or more structural units derived from the carboxylic acid-containing monomer is about 15% or higher, about 20% or higher, about 25% or higher, about 30% or higher, about 35% or higher, about 40% or higher, about 41% or higher, about 42% or higher, about 43% or higher, about 44% or higher, about 45% or higher, about 46% or higher, about 47% or higher, about 48% or higher, about 49% or higher, about 50% or higher, about 51% or higher, about 52% or higher, about 53% or higher, about 54% or higher, about 55% or higher, about 56% or higher, about 57% or higher, about 58% or higher, about 59% or higher, about 60% or higher, about 61% or higher, about 62% or higher, about 63% or higher, about 64% or higher, or about 65% or higher by mole, based on the total number of moles of monomeric units in the binder.

In some embodiments, the proportion of the one or more structural units derived from the amide-containing monomer is from about 10% to about 50%, from about 10% to about 45%, from about 10% to about 40%, from about 10% to about 35%, from about 10% to about 30%, from about 15% to about 50%, from about 15% to about 45%, from about 15% to about 40%, from about 15% to about 35%, from about 15% to about 30%, from about 20% to about 50%, from about 20% to about 45%, from about 20% to about 40%, from about 25% to about 50%, from about 25% to about 45%, from about 25% to about 40%, from about 30% to about 50%, or from about 30% to about 45% by mole, based on the total number of moles of monomeric units in the binder.

In some embodiments, the proportion of the one or more structural units derived from the amide-containing monomer is about 50% or lower, about 45% or lower, about 40% or lower, about 35% or lower, about 34% or lower, about 33% or lower, about 32% or lower, about 31% or lower, about 30% or lower, about 29% or lower, about 28% or lower, about 27% or lower, about 26% or lower, about 25% or lower, about 24% or lower, about 23% or lower, about 22% or lower, about 21% or lower, about 20% or lower, about 19% or lower, about 18% or lower, about 17% or lower, about 16% or lower, or about 15% or lower by mole, based on the total number of moles of monomeric units in the binder. In some embodiments, the proportion of the one or more structural units derived from the amide-containing monomer is about 10% or higher, about 11% or higher, about 12% or higher, about 13% or higher, about 14% or higher, about 15% or higher, about 16% or higher, about 17% or higher, about 18% or higher, about 19% or higher, about 20% or higher, about 21% or higher, about 22% or higher, about 23% or higher, about 24% or higher, about 25% or higher, about 26% or higher, about 27% or higher, about 28% or higher, about 29% or higher, about 30% or higher, or about 35% or higher by mole, based on the total number of moles of monomeric units in the binder.

In certain embodiments, the proportion of the one or more structural units derived from the nitrile-containing monomer is from about 10% to about 80%, from about 10% to about 75%, from about 10% to about 70%, from about 10% to about 65%, from about 10% to about 60%, from about 10% to about 55%, from about 10% to about 50%, from about 10% to about 45%, from about 10% to about 40%, from about 10% to about 35%, from about 10% to about 30%, from about 15% to about 80%, from about 15% to about 75%, from about 15% to about 70%, from about 15% to about 65%, from about 15% to about 60%, from about 15% to about 55%, from about 15% to about 50%, from about 15% to about 45%, from about 15% to about 40%, from about 15% to about 35%, from about 15% to about 30%, from about 20% to about 80%, from about 20% to about 75%, from about 20% to about 70%, from about 20% to about 65%, from about 20% to about 60%, from about 20% to about 55%, from about 20% to about 50%, from about 25% to about 80%, from about 25% to about 75%, from about 25% to about 70%, from about 25% to about 65%, from about 25% to about 60%, from about 25% to about 55%, or from about 25% to about 50% by mole, based on the total number of moles of monomeric units in the binder.

In some embodiments, the proportion of the one or more structural units derived from the nitrile-containing monomer is about 10% or higher, about 11% or higher, about 12% or higher, about 13% or higher, about 14% or higher, about 15% or higher, about 16% or higher, about 17% or higher, about 18% or higher, about 19% or higher, about 20% or higher, about 25% or higher, about 30% or higher, about 35% or higher, about 40% or higher, about 45% or higher, about 50% or higher, about 55% or higher, or about 60% or higher by mole, based on the total number of moles of monomeric units in the binder. In some embodiments, the proportion of the one or more structural units derived from the nitrile-containing monomer is about 80% or lower, about 75% or lower, about 70% or lower, about 65% or lower, about 60% or lower, about 55% or lower, about 50% or lower, about 45% or lower, about 40% or lower, about 35% or lower, about 30% or lower, or about 25% or lower by mole, based on the total number of moles of monomeric units in the binder.

In some embodiments, the pH of the binder composition is from about 7 to about 13, from about 7.5 to about 13, from about 8 to about 13, from about 8.5 to about 13, from about 9 to about 13, from about 7 to about 12.5, from about 7.5 to about 12.5, from about 8 to about 12.5, from about 8.5 to about 12.5, from about 9 to about 12.5, from about 7 to about 12, from about 7.5 to about 12, from about 8 to about 12, from about 8.5 to about 12, from about 9 to about 12, from about 7 to about 11.5, from about 7.5 to about 11.5, from about 8 to about 11.5, from about 8.5 to about 11.5, from about 9 to about 11.5, from about 7 to about 11, from about 7.5 to about 11, from about 8 to about 11, from about 8.5 to about 11, or from about 9 to about 11.

In certain embodiments, the pH of the binder composition is about 13 or less, about 12.5 or less, about 12 or less, about 11.5 or less, about 11 or less, about 10.5 or less, about 10 or less, about 9.5 or less, or about 9 or less. In certain embodiments, the pH of the binder composition is about 7 or more, about 7.5 or more, about 8 or more, about 8.5 or more, about 9 or more, about 9.2 or more, about 9.4 or more, about 9.6 or more, about 9.8 or more, about 10 or more, about 10.2 or more, about 10.4 or more, about 10.6 or more, about 10.8 or more, or about 11 or more.

Within the binder copolymer, the hydrophilic groups in the hydrophilic structural units interact with water readily since they can form hydrogen bonds or other polar interactions with water. Therefore, the presence of these hydrophilic groups helps ensure good dispersion of the copolymer in water. However, the hydrophilic groups of different copolymer chains in the binder can also interact with one another through mutual polar interactions or formation of hydrogen bonds. As a result, in the absence of a solvent, such as when the slurry containing the aqueous binder is dried to form the electrode, the copolymer chains of the binder would not be able to slide past one another easily due to intermolecular interactions between hydrophilic groups present between the copolymer chains. This leads to decreased flexibility in the binder and in an electrode containing such binder. Therefore, to increase the flexibility of the electrode, an additive is added to the electrode slurry.

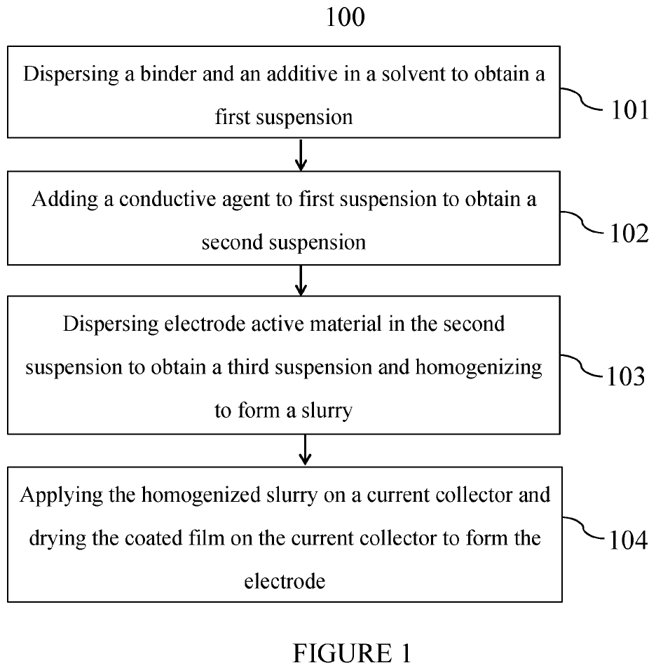

FIG. 1 is a flow chart of a method 100 for preparing one embodiment of the electrode slurry disclosed herein and preparing an electrode using the electrode slurry. In some embodiments, a first suspension is formed by dispersing a binder in a solvent in step 101. In certain embodiments, the first suspension further comprises an additive.

In certain embodiments, the amount of each of the binder material and the additive in the first suspension is independently from about 0.1% to about 5%, from about 0.2% to about 5%, from about 0.3% to about 5%, from about 0.4% to about 5%, from about 0.5% to about 5%, from about 0.6% to about 5%, from about 0.7% to about 5%, from about 0.8% to about 5%, from about 0.9% to about 5%, from about 1% to about 5%, from about 1.5% to about 5%, from about 2% to about 5%, from about 2.5% to about 5%, from about 0.1% to about 4.5%, from about 0.2% to about 4.5%, from about 0.3% to about 4.5%, from about 0.4% to about 4.5%, from about 0.5% to about 4.5%, from about 0.6% to about 4.5%, from about 0.7% to about 4.5%, from about 0.8% to about 4.5%, from about 0.9% to about 4.5%, from about 1% to about 4.5%, from about 1.5% to about 4.5%, from about 2% to about 4.5%, from about 2.5% to about 4.5%, from about 0.1% to about 4%, from about 0.2% to about 4%, from about 0.3% to about 4%, from about 0.4% to about 4%, from about 0.5% to about 4%, from about 0.6% to about 4%, from about 0.7% to about 4%, from about 0.8% to about 4%, from about 0.9% to about 4%, from about 1% to about 4%, from about 1.5% to about 4%, from about 2% to about 4%, from about 2.5% to about 4%, from about 0.1% to about 3.5%, from about 0.2% to about 3.5%, from about 0.3% to about 3.5%, from about 0.4% to about 3.5%, from about 0.5% to about 3.5%, from about 0.6% to about 3.5%, from about 0.7% to about 3.5%, from about 0.8% to about 3.5%, from about 0.9% to about 3.5%, from about 1% to about 3.5%, from about 1.5% to about 3.5%, from about 0.1% to about 3%, from about 0.2% to about 3%, from about 0.3% to about 3%, from about 0.4% to about 3%, from about 0.5% to about 3%, from about 0.6% to about 3%, from about 0.7% to about 3%, from about 0.8% to about 3%, from about 0.9% to about 3%, from about 1% to about 3%, from about 0.1% to about 2.5%, from about 0.2% to about 2.5%, from about 0.3% to about 2.5%, from about 0.4% to about 2.5%, from about 0.5% to about 2.5%, from about 0.6% to about 2.5%, from about 0.7% to about 2.5%, from about 0.8% to about 2.5%, from about 0.9% to about 2.5%, from about 1% to about 2.5%, from about 0.1% to about 2%, from about 0.2% to about 2%, from about 0.3% to about 2%, from about 0.4% to about 2%, from about 0.5% to about 2%, from about 0.6% to about 2%, from about 0.7% to about 2%, from about 0.8% to about 2%, from about 0.9% to about 2%, from about 1% to about 2%, from about 0.1% to about 1.5%, from about 0.2% to about 1.5%, from about 0.3% to about 1.5%, from about 0.4% to about 1.5%, from about 0.5% to about 1.5%, from about 0.6% to about 1.5%, from about 0.7% to about 1.5%, from about 0.8% to about 1.5%, from about 0.9% to about 1.5%, from about 1% to about 1.5%, from about 0.1% to about 1.2%, from about 0.2% to about 1.2%, from about 0.4% to about 1.2%, from about 0.5% to about 1.2%, from about 0.6% to about 1.2%, from about 0.7% to about 1.2%, from about 0.8% to about 1.2%, from about 0.1% to about 1%, from about 0.2% to about 1%, from about 0.3% to about 1%, from about 0.4% to about 1%, from about 0.5% to about 1%, from about 0.6% to about 1%, or from about 0.7% to about 1% by weight, based on the total weight of the first suspension.

In some embodiments, the amount of each of the binder material and the additive in the first suspension is independently about 5% or less, about 4.5% or less, about 4% or less, about 3.5% or less, about 3% or less, about 2.5% or less, about 2% or less, about 1.5% or less, or about 1% or less by weight, based on the total weight of the first suspension. In some embodiments, the amount of each of the binder material and the additive in the first suspension is independently about 0.1% or more, about 0.2% or more, about 0.3% or more, about 0.4% or more, about 0.5% or more, about 0.6% or more, about 0.7% or more, about 0.8% or more, about 0.9% or more, about 1% or more, about 1.5% or more, about 2% or more, about 2.5% or more, or about 3% or more by weight, based on the total weight of the first suspension.

The first suspension may be mixed for any time period and at any temperature that allows the first suspension to achieve good dispersion. The embodiments described below are non-limiting examples of the mixing time and temperature of the first suspension.

In some embodiments, the first suspension may be mixed for a time period from about 1 minute to about 60 minutes, from about 1 minute to about 50 minutes, from about 1 minute to about 45 minutes, from about 1 minute to about 40 minutes, from about 1 minute to about 30 minutes, from about 1 minute to about 25 minutes, from about 1 minute to about 20 minutes, from about 1 minute to about 15 minutes, from about 5 minutes to about 60 minutes, from about 5 minutes to about 50 minutes, from about 5 minutes to about 45 minutes, from about 5 minutes to about 40 minutes, from about 5 minutes to about 30 minutes, from about 10 minutes to about 60 minutes, from about 10 minutes to about 50 minutes, from about 10 minutes to about 45 minutes, from about 10 minutes to about 40 minutes, from about 10 minutes to about 30 minutes, from about 15 minutes to about 60 minutes, from about 15 minutes to about 50 minutes, from about 15 minutes to about 45 minutes, from about 20 minutes to about 60 minutes, from about 20 minutes to about 50 minutes, from about 20 minutes to about 45 minutes, from about 25 minutes to about 60 minutes, from about 25 minutes to about 50 minutes, from about 25 minutes to about 45 minutes, or from about 30 minutes to about 60 minutes.

In some embodiments, the first suspension may be mixed for a time period of about 1 minute or more, about 5 minutes or more, about 10 minutes or more, about 15 minutes or more, about 20 minutes or more, about 25 minutes or more, about 30 minutes or more, about 35 minutes or more, about 40 minutes or more, or about 45 minutes or more. In some embodiments, the first suspension may be mixed for a time period of about 60 minutes or less, about 55 minutes or less, about 50 minute or less, about 45 minutes or less, about 40 minutes or less, about 35 minutes or less, about 30 minutes or less, about 25 minutes or less, about 20 minutes or less, or about 15 minutes or less.

In certain embodiments, the first suspension is mixed at a temperature from about 10° C. to about 60° C., from about 10° C. to about 50° C., from about 10° C. to about 40° C., from about 10° C. to about 35° C., from about 10° C. to about 30° C., from about 10° C. to about 25° C., from about 15° C. to about 60° C., from about 15° C. to about 50° C., from about 15° C. to about 40° C., from about 20° C. to about 60° C., or from about 20° C. to about 50° C. In some embodiments, the first suspension is mixed at a temperature of 60° C. or below, 50° C. or below, 40° C. or below, 35° C. or below, 30° C. or below, or 25° C. or below. In other embodiments, the first suspension is mixed at a temperature of 10° C. or above, 15° C. or above, 20° C. or above, 25° C. or above, 30° C. or above, or 40° C. or above. In some embodiments, the first suspension is mixed at a temperature of about 60° C., about 50° C., about 40° C., about 35° C., about 30° C., about 25° C., about 20° C., about 15° C., or about 10° C. In some embodiments, the first suspension is mixed at room temperature.

In some embodiments, the second suspension is formed by adding a conductive agent into the first suspension in step 102.

In certain embodiments, the conductive agent is a carbonaceous material selected from the group consisting of carbon, carbon black, graphite, expanded graphite, graphene, graphene nanoplatelets, carbon fibers, carbon nano-fibers, graphitized carbon flake, carbon tubes, carbon nanotubes, activated carbon, mesoporous carbon, and combinations thereof. In certain embodiments, the conductive agent does not comprise a carbonaceous material.

In some embodiments, the conductive agent is a conductive polymer. In certain embodiments, the conductive polymer is selected from the group consisting of polypyrrole, polyaniline, polyacetylene, polyphenylene sulfide (PPS), polyphenylene vinylene (PPV), poly(3,4-ethylenedioxythiophene) (PEDOT), polythiophene and combinations thereof. In other embodiments, the conductive agent is not a conductive polymer. In some embodiments, the conductive agent also acts as a binder.

The second suspension may be mixed for any time period and at any temperature that allows the second suspension to achieve good dispersion. The mixing time and temperature can be the same as the numerical ranges described above for the mixing time and temperature of the first suspension respectively.

In some embodiments, the third suspension is formed by dispersing an electrode active material into the second suspension at step 103.

In some embodiments, the electrode slurry is for a cathode and the electrode active material is a cathode active material. In some embodiments, the cathode active material is selected from the group consisting of LiCoO₂, LiNiO₂, LiNixMn_{y}O₂, LiCoxNi_{y}O₂, Li_{1+z}NiₓMn—_{y}Co_{1-x-y}O₂, LiNiₓCo_{y}Al_{z}O₂, LiV₂O₅, LiTiS₂, LiMoS₂, LiMnO₂, LiCrO₂, LiMn₂O₄, Li₂MnO₃, LiFeO₂, LiFePO₄, and combinations thereof, wherein each x is independently from 0.1 to 0.9; each y is independently from 0 to 0.9; each z is independently from 0 to 0.4.

In certain embodiments, the cathode active material is selected from the group consisting of LiCoO₂, LiNiO₂, LiNiₓMn_{y}O₂, Li_{1+z}NiₓMn_{y}Co_{1-x-y}O₂ (NMC), LiNixCo_{y}Al_{z}O₂, LiV₂O₅, LiTiS₂, LiMoS₂, LiMnO₂, LiCrO₂, LiMn₂O₄, LiFeO₂, LiFePO₄, LiCoₓNi_{y}O₂, and combinations thereof, wherein each x is independently from 0.4 to 0.6; each y is independently from 0.2 to 0.4; and each z is independently from 0 to 0.1. In other embodiments, the cathode active material is not LiCoO₂, LiNiO₂, LiV₂O₅, LiTiS₂, LiMoS₂, LiMnO₂, LiCrO₂, LiMn₂O₄, LiFeO₂, or LiFePO₄. In further embodiments, the cathode active material is not LiNiₓMn_{y}O₂, Li_{1+z}NiₓMn_{y}Co_{1-x-y}O₂, LiNiₓCo_{y}Al_{z}O₂ or LiCoₓNi_{y}O₂, wherein each x is independently from 0.1 to 0.9; each y is independently from 0 to 0.45; and each z is independently from 0 to 0.2. In certain embodiments, the cathode active material is Li₁₊ₓNiₐMn_{b}Co_{c}Al_{(1-a-b-c)}O₂: wherein −0.2≤x≤0.2, 0≤a<1, 0≤b<1, 0≤c<1, and a+b+c≤1.

In some embodiments, the cathode active material has the general formula LiMPO₄, wherein M is selected from the group consisting of Fe, Co, Ni, Mn, Al, Mg, Zn, Ti, La, Ce, Sn, Zr, Ru, Si, Ge and combinations thereof. In some embodiments, the cathode active material is selected from the group consisting of LiFePO₄, LiCoPO₄, LiNiPO₄, LiMnPO₄, LiMnFePO₄, LiMn_{d}Fe_{(1-d)}PO₄ and combinations thereof; wherein 0<d<1. In some embodiments, the cathode active material is LiNiₑMn_{f}O₄; wherein 0.1≤e≤0.9 and 0≤f≤2. In certain embodiments, the cathode active material is dLi₂MnO₃·(1−d)LiMO₂, wherein M is selected from the group consisting of Ni, Co, Mn, Fe and combinations thereof; and wherein 0<d<1. In some embodiments, the cathode active material is Li₃V₂(PO₄)₃, LiVP₄F. In certain embodiments, the cathode active material has the general formula Li2MSiO4, wherein M is selected from the group consisting of Fe, Co, Mn, Ni, and combinations thereof.

In certain embodiments, the cathode active material is doped with a dopant selected from the group consisting of Co, Cr, V, Mo, Nb, Pd, F, Na, Fe, Ni, Mn, Al, Mg, Zn, Ti, La, Ce, Sn, Zr, Ru, Si, Ge, and combinations thereof. In some embodiments, the dopant is not Co, Cr, V, Mo, Nb, Pd, F, Na, Fe, Ni, Mn, Mg, Zn, Ti, La, Ce, Ru, Si, or Ge. In certain embodiments, the dopant is not Al, Sn, or Zr.

In some embodiments, the cathode active material is LiNi_{0.33}Mn_{0.33}Co_{0.33}O₂ (NMC333), LiNi_{0.4}Mn_{0.4}Co_{0.2}O₂, LiNi_{0.5}Mn_{0.3}Co_{0.2}O₂ (NMC532), LiNi_{0.6}Mn_{0.2}Co_{0.2}O₂ (NMC622), LiNi_{0.7}Mn_{0.15}Co_{0.15}O₂, LiNi_{0.7}Mn_{0.1}Co_{0.2}O₂, LiNi0.8Mn_{0.1}Co_{0.1}O₂ (NMC811), LiNi_{0.92}Mn_{0.04}Co_{0.04}O₂, LiNi_{0.8}Co_{0.15}Al_{0.05}O₂ (NCA), LiNiO₂ (LNO), and combinations thereof.

In other embodiments, the cathode active material is not LiCoO₂, LiNiO₂, LiMnO₂, LiMn₂O₄, or Li₂MnO₃. In further embodiments, the cathode active material is not LiNi_{0.33}Mn_{0.33}Co_{0.33}O₂, LiNi_{0.4}Mn_{0.4}Co_{0.2}O₂, LiNi_{0.5}Mn_{0.3}Co_{0.2}O₂, LiNi_{0.6}Mn_{0.2}Co_{0.2}O₂, LiNi_{0.7}Mn_{0.15}Co_{0.15}O₂, LiNi_{0.7}Mn_{0.1}Co_{0.2}O₂, LiNi_{0.8}Mn_{0.1}Co_{0.1}O₂, LiNi_{0.92}Mn_{0.04}Co_{0.04}O₂, or LiNi_{0.8}Co_{0.15}Al_{0.05}O₂.

In certain embodiments, the cathode active material comprises or is a core-shell composite having a core and shell structure, wherein the core and the shell each independently comprise a lithium transition metal oxide selected from the group consisting of Li₁₊ₓNiₐMn_{b}Co_{c}Al_{(1-a-b-c)}O₂, LiCoO₂, LiNiO₂, LiMnO₂, LiMn₂O₄, Li₂MnO₃, LiCrO₂, Li₄Ti₅O₁₂, LiV₂O₅, LiTiS₂, LiMoS₂, LiCoₐNi_{b}O₂, LiMnₐNi_{b}O₂, and combinations thereof; wherein −0.2≤x≤0.2, 0≤a<1, 0≤b<1, 0≤c<1, and a+b+c≤1.

In some embodiments, each of the lithium transition metal oxides in the core and the shell is independently doped with a dopant selected from the group consisting of Co, Cr, V, Mo, Nb, Pd, F, Na, Fe, Ni, Mn, Al, Mg, Zn, Ti, La, Ce, Sn, Zr, Ru, Si, Ge, and combinations thereof. In certain embodiments, the core and the shell each independently comprise two or more doped lithium transition metal oxides. In some embodiments, the two or more doped lithium transition metal oxides are uniformly distributed over the core and/or the shell. In certain embodiments, the two or more doped lithium transition metal oxides are not uniformly distributed over the core and/or the shell.

In some embodiments, the cathode active material comprises or is a core-shell composite comprising a core comprising a lithium transition metal oxide and a shell comprising a transition metal oxide. In certain embodiments, the lithium transition metal oxide is selected from the group consisting of Li₁₊ₓNiₐMn_{b}Co_{c}Al_{(1-a-b-c)}P₂, LiCoO₂, LiNiO₂, LiMnO₂, LiMn₂O₄, Li₂MnO₃, LiCrO₂, Li₄Ti₅O₁₂, LiV₂O₅, LiTiS₂, LiMoS₂, LiFePO₄, LiCoₐNi_{b}O₂, LiMnₐNi_{b}O₂, and combinations thereof; wherein −0.2≤x≤0.2, 0≤a<1, 0≤b<1, 0≤c<1, and a+b+c≤1. In certain embodiments, the core comprises a nickel-containing lithium transition metal oxide selected from the group consisting of LiNi_{0.33}Mn_{0.33}Co_{0.33}O₂, LiNi_{0.4}Mn_{0.4}Co_{0.2}O₂, LiNi_{0.5}Mn_{0.3}Co_{0.2}O₂, LiNi_{0.6}Mn_{0.2}Co_{0.2}O₂, LiNi_{0.7}Mn_{0.15}Co_{0.15}O₂, LiNi_{0.7}Mn_{0.1}Co_{0.2}O₂, LiNi_{0.8}Mn_{0.1}Co_{0.1}O₂, LiNi_{0.92}Mn_{0.04}Co_{0.04}O₂, LiNi_{0.8}Co_{0.15}Al_{0.05}O₂, LiNiO₂, and combinations thereof. In some embodiments, the transition metal oxide is selected from the group consisting of Fe₂O₃, MnO₂, Al₂O₃, MgO, ZnO, TiO₂, La₂O₃, CeO₂, SnO₂, ZrO₂, RuO₂, and combinations thereof. In certain embodiments, the shell comprises a lithium transition metal oxide and a transition metal oxide.

In certain embodiments, the cathode active material comprises or is a core-shell composite having a core and shell structure, wherein the core and the shell each independently comprise a lithium transition metal oxide selected from the group consisting of Li₁₊ₓNiₐMn_{b}Co_{c}Al_{(1-a-b-c)}O₂, LiCoO₂, LiNiO₂, LiMnO₂, LiMn₂O₄, Li₂MnO₃, LiCrO₂, Li₄Ti₅O₁₂, LiV₂O₅, LiTiS₂, LiMoS₂, LiFePO₄, and combinations thereof; wherein −0.2≤x≤0.2, 0≤a<1, 0≤b<1, 0≤c<1, and a+b+c≤1. In certain embodiments, at least one of the core or the shell comprises a nickel-containing lithium transition metal oxide selected from the group consisting of LiNi_{0.33}Mn_{0.33}Co_{0.33}O₂, LiNi_{0.4}Mn_{0.4}Co_{0.2}O₂, LiNi_{0.5}Mn_{0.3}Co_{0.2}O₂, LiNi_{0.6}Mn_{0.2}Co_{0.2}O₂, LiNi_{0.7}Mn_{0.15}Co_{0.15}O₂, LiNi_{0.7}Mn_{0.1}Co_{0.2}O₂, LiNi_{0.8}Mn_{0.1}Co_{0.1}O₂, LiNi_{0.92}Mn_{0.04}Co_{0.04}O₂, LiNi_{0.8}Co_{0.15}Al_{0.05}O₂, LiNiO₂, and combinations thereof.

In some embodiments, the core and the shell each independently comprise two or more lithium transition metal oxides. In some embodiments, one of the core or shell comprises only one lithium transition metal oxide, while the other comprises two or more lithium transition metal oxides. The lithium transition metal oxide or oxides in the core and the shell may be the same, or they may be different or partially different. In some embodiments, the two or more lithium transition metal oxides are uniformly distributed over the core. In certain embodiments, the two or more lithium transition metal oxides are not uniformly distributed over the core. In some embodiments, the cathode active material is not a core-shell composite.

In some embodiments, the diameter of the core is from about 1 μm to about 15 μm, from about 3 μm to about 15 μm, from about 3 μm to about 10 μm, from about 5 μm to about 10 μm, from about 5 μm to about 45 μm, from about 5 μm to about 35 μm, from about 5 μm to about 25 μm, from about 10 μm to about 45 μm, from about 10 μm to about 40 μm, from about 10 μm to about 35 μm, from about 10 μm to about 25 μm, from about 15 μm to about 45 μm, from about 15 μm to about 30 μm, from about 15 μm to about 25 μm, from about 20 μm to about 35 μm, or from about 20 μm to about 30 μm. In certain embodiments, the thickness of the shell is from about 1 μm to about 45 μm, from about 1 μm to about 35 μm, from about 1 μm to about 25 μm, from about 1 μm to about 15 μm, from about 1 μm to about 10 μm, from about 1 μm to about 5 μm, from about 3 μm to about 15 μm, from about 3 μm to about 10 μm, from about 5 μm to about 10 μm, from about 10 μm to about 35 μm, from about 10 μm to about 20 μm, from about 15 μm to about 30 μm, from about 15 μm to about 25 μm, or from about 20 μm to about 35 μm. In certain embodiments, the diameter or thickness ratio of the core and the shell are in the range of 15:85 to 85:15, 25:75 to 75:25, 30:70 to 70:30, or 40:60 to 60:40. In certain embodiments, the volume or weight ratio of the core and the shell is 95:5, 90:10, 80:20, 70:30, 60:40, 50:50, 40:60, or 30:70.

In some embodiments, the electrode slurry is for an anode and the electrode active material is an anode active material. In some embodiments, the anode active material is selected from the group consisting of natural graphite particulate, synthetic graphite particulate, Sn (tin) particulate, Li₄Ti₅O₁₂ particulate, Si (silicon) particulate, Si—C composite particulate, and combinations thereof.

In some embodiments, the particle size D50 of the electrode active material is from about 0.1 μm to about 20 μm, from about 0.3 μm to about 20 μm, from about 0.5 μm to about 20 μm, from about 0.8 μm to about 20 μm, from about 1 μm to about 20 μm, from about 2 μm to about 20 μm, from about 3 μm to about 20 μm, from about 4 μm to about 20 μm, from about 5 μm to about 20 μm, from about 6 μm to about 20 μm, from about 8 μm to about 20 μm, from about 10 μm to about 20 μm, from about 12 μm to about 20 μm, from about 14 μm to about 20 μm, from about 3 μm to about 18 μm, from about 4 μm to about 18 μm, from about 5 μm to about 18 μm, from about 6 μm to about 18 μm, from about 8 μm to about 18 μm, from about 10 μm to about 18 μm, from about 12 μm to about 18 μm, from about 3 μm to about 16 μm, from about 4 μm to about 16 μm, from about 5 μm to about 16 μm, from about 6 μm to about 16 μm, from about 8 μm to about 16 μm, from about 3 μm to about 15 μm, from about 4 μm to about 15 μm, from about 5 μm to about 15 μm, from about 6 μm to about 15 μm, from about 8 μm to about 15 μm, from about 3 μm to about 14 μm, from about 4 μm to about 14 μm, from about 5 μm to about 14 μm, from about 6 μm to about 14 μm, from about 8 μm to about 14 μm, from about 3 μm to about 12 μm, from about 4 μm to about 12 μm, from about 5 μm to about 12 μm, from about 6 μm to about 12 μm, from about 3 μm to about 10 μm, from about 4 μm to about 10 μm, from about 5 μm to about 10 μm, from about 0.1 μm to about 5 μm, from about 0.3 μm to about 5 μm, from about 0.5 μm to about 5 μm, from about 0.8 μm to about 5 μm, from about 1 μm to about 5 μm, from about 2 μm to about 5 μm, from about 0.1 μm to about 4 μm, from about 0.3 μm to about 4 μm, from about 0.5 μm to about 4 μm, from about 0.8 μm to about 4 μm, from about 1 μm to about 4 μm, from about 2 μm to about 4 μm, from about 0.1 μm to about 3 μm, from about 0.3 μm to about 3 μm, from about 0.5 μm to about 3 μm, from about 0.8 μm to about 3 μm, from about 1 μm to about 3 μm, from about 0.1 μm to about 2.5 μm, from about 0.3 μm to about 2.5 μm, from about 0.5 μm to about 2.5 μm, from about 0.8 μm to about 2.5 μm, from about 1 μm to about 2.5 μm, from about 2 μm to about 2.5 μm, from about 0.1 μm to about 2 μm, from about 0.3 μm to about 2 μm, from about 0.5 μm to about 2 μm, from about 0.8 μm to about 2 μm, from about 1 μm to about 2 μm, from about 0.1 μm to about 1 μm, from about 0.3 μm to about 1 μm, from about 0.5 μm to about 1 μm, or from about 0.8 μm to about 1 μm.

In some embodiments, the particle size D50 of the electrode active material is about 20 μm or smaller, about 19 μm or smaller, about 18 μm or smaller, about 17 μm or smaller, about 16 μm or smaller, about 15 μm or smaller, about 14 μm or smaller, about 13 μm or smaller, about 12 μm or smaller, about 11 μm or smaller, about 10 μm or smaller, about 9 μm or smaller, about 8 μm or smaller, about 7 μm or smaller, about 6 μm or smaller, about 5 μm or smaller, about 4 μm or smaller, or about 3 μm or smaller. In some embodiments, the particle size D50 of the electrode active material is about 0.1 μm or greater, about 0.2 μm or greater, about 0.5 μm or greater, about 1 μm or greater, about 2 μm or greater, about 3 μm or greater, about 4 μn or greater, about 5 μm or greater, about 6 μm or greater, about 7 μm or greater, about 8 μm or greater, about 9 μm or greater, about 10 μm or greater, about 11 μm or greater, about 12 μm or greater, about 13 μm or greater, about 14 μm or greater, or about 15 μm or greater.

In some embodiments, mixing the binder and the conductive agent in the first suspension can be done before adding the additive. This can be advantageous as it allows better dispersion of materials in the second suspension. In some embodiments, the binder, the conductive agent and the additive can be mixed to form a first suspension. A second suspension can then be formed by dispersing the electrode active material in the first suspension. In other embodiments, the binder and the additive can be mixed to form a first suspension. Thereafter, a second suspension can be formed by dispersing the electrode active material and/or conductive agent in the first suspension. If only one of the electrode active material or conductive agent is added to form the second suspension, the other can then be dispersed in the second suspension to form a third suspension.

The components of the electrode slurry do not have to be added in any particular order so long as the components can be mixed thoroughly. The binder, additive, electrode active material and conductive agent may each be added at any step of the process before the homogenized electrode slurry is formed.

The third suspension is homogenized by a homogenizer to obtain a homogenized electrode slurry. The homogenizer may be equipped with a temperature control system and the temperature of the third suspension can be controlled by the temperature control system. Any homogenizer that can reduce or eliminate particle aggregation, and/or promote homogeneous distribution of slurry ingredients can be used herein. Homogeneous distribution plays an important role in fabricating batteries with good battery performance. In some embodiments, the homogenizer is a planetary mixer, a stirring mixer, a blender, or an ultrasonicator.

The third suspension can be homogenized at any temperature so long as a homogenized electrode slurry is achieved. In some embodiments, the third suspension is homogenized at a temperature from about 10° C. to about 40° C., from about 10° C. to about 35° C., from about 10° C. to about 30° C., from about 10° C. to about 25° C., from about 15° C. to about 40° C., from about 15° C. to about 35° C., from about 15° C. to about 30° C., or from about 20° C. to about 40° C. In some embodiments, the third suspension is homogenized at a temperature of about 40° C. or less, about 35° C. or less, about 30° C. or less, about 25° C. or less, about 20° C. or less, or about 15° C. or less. In some embodiments, the third suspension is homogenized at a temperature of about 10° C. or more, about 15° C. or more, about 20° C. or more, or about 25° C. or more. In some embodiments, the third suspension is homogenized at room temperature.

In some embodiments, the planetary stirring mixer comprises at least one planetary blade and at least one high-speed dispersion blade. In certain embodiments, the rotational speed of the planetary blade is from about 20 rpm to about 200 rpm, from about 20 rpm to about 150 rpm, from about 30 rpm to about 150 rpm, or from about 50 rpm to about 100 rpm. In certain embodiments, the rotational speed of the dispersion blade is from about 1,000 rpm to about 4,000 rpm, from about 1,000 rpm to about 3,500 rpm, from about 1,000 rpm to about 3,000 rpm, from about 1,000 rpm to about 2,000 rpm, from about 1,500 rpm to about 3,000 rpm, or from about 1,500 rpm to about 2,500 rpm.

In certain embodiments, the ultrasonicator is an ultrasonic bath, a probe-type ultrasonicator or an ultrasonic flow cell. In some embodiments, the ultrasonicator is operated at a power density from about 10 W/L to about 100 W/L, from about 20 W/L to about 100 W/L, from about 30 W/L to about 100 W/L, from about 40 W/L to about 80 W/L, from about 40 W/L to about 70 W/L, from about 40 W/L to about 60 W/L, from about 40 W/L to about 50 W/L, from about 50 W/L to about 60 W/L, from about 20 W/L to about 80 W/L, from about 20 W/L to about 60 W/L, or from about 20 W/L to about 40 W/L. In certain embodiments, the ultrasonicator is operated at a power density of about 10 W/L, about 20 W/L, about 30 W/L, about 40 W/L, about 50 W/L, about 60 W/L, about 70 W/L, about 80 W/L, about 90 W/L, or about 100 W/L.

The third suspension can be homogenized for any time period so long as a homogenized electrode slurry is achieved. In some embodiments, the third suspension is homogenized for a time period from about 10 minutes to about 6 hours, from about 10 minutes to about 5 hours, from about 10 minutes to about 4 hours, from about 10 minutes to about 3 hours, from about 10 minutes to about 2 hours, from about 10 minutes to about 1 hour, from about 10 minutes to about 30 minutes, from about 30 minutes to about 3 hours, from about 30 minutes to about 2 hours, from about 30 minutes to about 1 hour, from about 1 hour to about 6 hours, from about 1 hour to about 5 hours, from about 1 hour to about 4 hours, from about 1 hour to about 3 hours, from about 1 hour to about 2 hours, from about 2 hours to about 6 hours, from about 2 hours to about 4 hours, from about 2 hours to about 3 hours, from about 3 hours to about 5 hours, or from about 4 hours to about 6 hours. In certain embodiments, the third suspension is homogenized for a time period of about 6 hours or less, about 5 hours or less, about 4 hours or less, about 3 hours or less, about 2 hours or less, about 1 hour or less, or about 30 minutes or less. In some embodiments, the third suspension is homogenized for a time period of about 4 hours or more, about 3 hours or more, about 2 hours or more, about 1 hour or more, about 30 minutes or more, about 20 minutes or more, or about 10 minutes or more.

In some embodiments, before homogenization of the third suspension, the third suspension is degassed under a reduced pressure for a short period of time to remove air bubbles trapped in the suspension. In some embodiments, the third suspension is degassed at a pressure from about 1 kPa to about 20 kPa, from about 1 kPa to about 15 kPa, from about 1 kPa to about 10 kPa, from about 5 kPa to about 20 kPa, from about 5 kPa to about 15 kPa, or from about 10 kPa to about 20 kPa. In certain embodiments, the third suspension is degassed at a pressure about 20 kPa or less, about 15 kPa or less, or about 10 kPa or less. In some embodiments, the third suspension is degassed for a time period from about 30 minutes to about 4 hours, from about 1 hour to about 4 hours, from about 2 hours to about 4 hours, or from about 30 minutes to about 2 hours. In certain embodiments, the third suspension is degassed for a time period about 4 hours or less, about 2 hours or less, or about 1 hour or less.

In certain embodiments, the third suspension is degassed after homogenization, which may be performed at the pressures and for the time durations stated in the step of degassing the third suspension before homogenization.

In certain embodiments, the first and second suspensions may independently be degassed before or after mixing, which may be performed at the pressures and for the time durations stated in the step of degassing the third suspension before homogenization.

In some embodiments, the pH of the homogenized electrode slurry is from about 8 to about 14, from about 8 to about 13.5, from about 8 to about 13, from about 8 to about 12.5, from about 8 to about 12, from about 8 to about 11.5, from about 8 to about 11, from about 8 to about 10.5, from about 8 to about 10, from about 9 to about 14, from about 9 to about 13, from about 9 to about 12, from about 9 to about 11, from about 10 to about 14, from about 10 to about 13, from about 10 to about 12, from about 10.5 to about 14, from about 10.5 to about 13.5, from about 10.5 to about 13, from about 10.5 to about 12.5, from about 11 to about 14, or from about 12 to about 14. In certain embodiments, the pH of the homogenized electrode slurry is about 14 or less, about 13.5 or less, about 13 or less, about 12.5 or less, about 12 or less, about 11.5 or less, about 11 or less, about 10.5 or less, about 10 or less, or about 9.5 or less. In some embodiments, the pH of the homogenized electrode slurry is about 8 or more, about 8.5 or more, about 9 or more, about 9.5 or more, about 10 or more, about 10.5 or more, about 11 or more, about 11.5 or more, or about 12 or more.

In certain embodiments, the change in pH observed during homogenization is from about 0.01 pH units to about 0.5 pH units, from about 0.01 pH units to about 0.45 pH units, from about 0.01 pH units to about 0.4 pH units, from about 0.01 pH units to about 0.35 pH units, from about 0.01 pH units to about 0.3 pH units, from about 0.01 pH units to about 0.25 pH units, from about 0.01 pH units to about 0.2 pH units, from about 0.01 pH units to about 0.15 pH units, or from about 0.01 pH units to about 0.1 pH units. In certain embodiments, the decrease in pH observed during homogenization is about 0.5 pH units or less, about 0.45 pH units or less, about 0.4 pH units or less, about 0.35 pH units or less, about 0.3 pH units or less, about 0.2 pH units or less, or about 0.1 pH units or less.

In certain embodiments, the amount of the binder and the conductive agent in the homogenized electrode slurry is each independently from about 0.5% to about 5%, from about 0.5% to about 4.5%, from about 0.5% to about 4%, from about 0.5% to about 3.5%, from about 0.5% to about 3%, from about 1% to about 5%, from about 1% to about 4.5%, from about 1% to about 4%, from about 1% to about 3.5%, from about 1.5% to about 5%, from about 1.5% to about 4.5%, or from about 2% to about 5% by weight, based on the total weight of the solid content of the homogenized electrode slurry. In some embodiments, the amount of the binder and the conductive agent in the homogenized electrode slurry is each independently about 0.5% or more, about 1% or more, about 1.5% or more, about 2% or more, about 2.5% or more, about 3% or more, or about 3.5% or more by weight, based on the total weight of the solid content of the homogenized electrode slurry. In certain embodiments, the amount of the binder and conductive agent in the homogenized electrode slurry is each independently about 5% or less, about 4.5% or less, about 4% or less, about 3.5% or less, or about 3% or less by weight, based on the total weight of the solid content of the homogenized electrode slurry.

In some embodiments, the weight of the binder material is greater than, smaller than, or equal to the weight of the conductive agent in the homogenized electrode slurry. In certain embodiments, the ratio of the weight of the binder material to the weight of the conductive agent is from about 1:10 to about 10:1, from about 1:10 to about 5:1, from about 1:10 to about 1:1, from about 1:10 to about 1:5, from about 1:5 to about 5:1, from about 1:3 to about 3:1, from about 1:2 to about 2:1, or from about 1:1.5 to about 1.5:1.

In certain embodiments, the amount of the electrode active material in the homogenized electrode slurry is about 20% or more, about 30% or more, about 35% or more, about 40% or more, about 45% or more, about 50% or more, about 55% or more, or about 60% or more by weight, based on the total weight of the homogenized electrode slurry. In some embodiments, the amount of the electrode active material in the homogenized electrode slurry is about 50% or less, about 55% or less, about 60% or less, about 65% or less, about 70% or less, about 75% or less, or about 80% or less by weight, based on the total weight of the homogenized electrode slurry.

In some embodiments, the amount of the electrode active material in the homogenized electrode slurry is from about 20% to about 80%, from about 20% to about 75%, from about 20% to about 70%, from about 20% to about 65%, from about 20% to about 60%, from about 20% to about 55%, from about 20% to about 50%, from about 25% to about 80%, from about 25% to about 75%, from about 25% to about 70%, from about 25% to about 65%, from about 25% to about 60%, from about 25% to about 55%, from about 25% to about 50%, from about 30% to about 80%, from about 30% to about 75%, from about 30% to about 70%, from about 30% to about 65%, from about 30% to about 60%, from about 40% to about 80%, from about 40% to about 75%, from about 40% to about 70%, from about 40% to about 65%, from about 50% to about 80%, or from about 50% to about 75% by weight, based on the total weight of the homogenized electrode slurry. In certain embodiments, the amount of the electrode active material in the homogenized electrode slurry is about 20%, about 30%, about 45%, about 50%, about 65%, about 70%, about 75%, or about 80% by weight, based on the total weight of the homogenized electrode slurry.

In certain embodiments, the amount of the electrode active material in the homogenized electrode slurry is about 40% or more, about 45% or more, about 50% or more, about 55% or more, about 60% or more, about 65% or more, about 70% or more, about 75% or more, about 80% or more, about 85% or more, or about 90% or more by weight, based on the total weight of the solid content of the homogenized electrode slurry. In some embodiments, the amount of the electrode active material in the homogenized electrode slurry is about 99% or less, about 95% or less, about 90% or less, about 85% or less, about 80% or less, about 75% or less, or about 70% or less by weight, based on the total weight of the solid content of the homogenized electrode slurry.

In some embodiments, the amount of the electrode active material in the homogenized electrode slurry is from about 40% to about 99%, from about 40% to about 95%, from about 40% to about 90%, from about 40% to about 85%, from about 40% to about 80%, from about 40% to about 75%, from about 40% to about 70%, from about 50% to about 99%, from about 50% to about 95%, from about 50% to about 90%, from about 50% to about 85%, from about 50% to about 80%, from about 50% to about 75%, from about 50% to about 70%, from about 60% to about 99%, from about 60% to about 95%, from about 60% to about 90%, from about 60% to about 85%, from about 60% to about 80%, from about 60% to about 75%, from about 70% to about 99%, from about 70% to about 95%, from about 70% to about 90%, from about 70% to about 85%, from about 75% to about 99%, from about 75% to about 95%, from about 75% to about 90%, from about 75% to about 85%, from about 80% to about 99%, from about 80% to about 95%, or from about 80% to about 90% by weight, based on the total weight of the solid content of the homogenized electrode slurry. In certain embodiments, the amount of the electrode active material in the homogenized electrode slurry is about 40%, about 50%, about 60%, about 70%, about 75%, about 80%, about 85%, about 90%, about 93%, or about 95% by weight, based on the total weight of the solid content of the homogenized electrode slurry.

In some embodiments, the particle size D50 of the homogenized electrode slurry is from about 3 μm to about 20 μm, from about 4 μm to about 20 μm, from about 5 μm to about 20 μm, from about 6 μm to about 20 μm, from about 8 μm to about 20 μm, from about 10 μm to about 20 μm, from about 12 μm to about 20 μm, from about 14 μm to about 20 μm, from about 3 μm to about 18 μm, from about 4 μm to about 18 μm, from about 5 μm to about 18 μm, from about 6 μm to about 18 μm, from about 8 μm to about 18 μm, from about 10 μm to about 18 inn, from about 12 μm to about 18 μm, from about 3 μm to about 16 μm, from about 4 μm to about 16 μm, from about 5 μm to about 16 μm, from about 6 μm to about 16 μm, from about 8 inn to about 16 μm, from about 3 μm to about 15 μm, from about 4 μm to about 15 μm, from about 5 μm to about 15 μm, from about 6 μm to about 15 μm, from about 8 μm to about 15 μm, from about 3 μm to about 14 μm, from about 4 μm to about 14 μm, from about 5 μm to about 14 inn, from about 6 μm to about 14 μm, from about 8 μm to about 14 μm, from about 3 μm to about 12 μm, from about 4 μm to about 12 μm, from about 5 μm to about 12 μm, from about 6 inn to about 12 μm, from about 3 μm to about 10 μm, from about 4 μm to about 10 μm, or from about 5 μm to about 10 μm.

In some embodiments, the particle size D50 of the homogenized electrode slurry is about 20 μm or smaller, about 19 μm or smaller, about 18 μm or smaller, about 17 μm or smaller, about 16 μm or smaller, about 15 μm or smaller, about 14 μm or smaller, about 13 μm or smaller, about 12 μm or smaller, about 11 μm or smaller, about 10 μm or smaller, about 9 μm or smaller, about 8 μm or smaller, about 7 μm or smaller, about 6 μm or smaller, or about 5 μm or smaller. In some embodiments, the particle size D50 of the homogenized electrode slurry is about 3 μm or greater, about 4 μm or greater, about 5 μm or greater, about 6 μm or greater, about 7 μm or greater, about 8 μm or greater, about 9 μm or greater, about 10 μm or greater, about 11 μm or greater, about 12 μm or greater, about 13 μm or greater, about 14 μm or greater, or about 15 μm or greater.

In some embodiments, the solid content of the homogenized electrode slurry is from about 40% to about 80%, from about 45% to about 75%, from about 45% to about 70%, from about 45% to about 65%, from about 45% to about 60%, from about 50% to about 80%, from about 50% to about 75%, from about 50% to about 70%, from about 55% to about 80%, from about 55% to about 75%, from about 55% to about 70%, or from about 60% to about 80% by weight, based on the total weight of the homogenized electrode slurry. In certain embodiments, the solid content of the homogenized electrode slurry is about 40%, about 45%, about 50%, about 55%, about 60%, about 65%, about 70%, about 75%, or about 80% by weight, based on the total weight of the homogenized electrode slurry. In certain embodiments, the solid content of the homogenized electrode slurry is at least 40%, at least 45%, at least 50%, at least 55%, at least 60%, at least 65%, or at least 70% by weight, based on the total weight of the homogenized electrode slurry. In certain embodiments, the solid content of the homogenized electrode slurry is at most 80%, at most 75%, at most 70%, at most 65%, at most 60%, at most 55%, or at most 50% by weight, based on the total weight of the homogenized electrode slurry.

In some embodiments, the solvent of the first, second and third suspensions and the homogenized electrode slurry is independently water. Some non-limiting examples of water include tap water, bottled water, purified water, pure water, distilled water, de-ionized water, D20, and combinations thereof.

In some embodiments, the solvent of the first, second and third suspensions and the homogenized electrode slurry is independently a solvent mixture comprising water as a major component and a volatile solvent, such as alcohols, lower aliphatic ketones, lower alkyl acetates or the like, as a minor component in addition to the water. According to the invention, the amount of water in the first, second and third suspensions and the homogenized electrode slurry is independently at least 50%, based on the total weight or volume of the solvent mixture.

Any water-miscible solvents can be used as the minor component. Some non-limiting examples of the minor component (i.e., solvents other than water) include alcohols, lower aliphatic ketones, lower alkyl acetates and combinations thereof. Some non-limiting examples of the alcohol include C₁-C₄ alcohols, such as methanol, ethanol, isopropanol, n-propanol, butanol, and combinations thereof. Some non-limiting examples of the lower aliphatic ketones include acetone, dimethyl ketone, and methyl ethyl ketone. Some non-limiting examples of the lower alkyl acetates include ethyl acetate, isopropyl acetate, and propyl acetate.

In certain embodiments, the volatile solvent or the minor component is selected from the group consisting of methyl ethyl ketone, ethanol, ethyl acetate, isopropanol, n-propanol, t-butanol, n-butanol, and combinations thereof. In some embodiments, the volume ratio of water and the minor component is from about 51:49 to about 99:1. In certain embodiments, the solvent of the first, second and third suspensions and the homogenized electrode slurry is independently free of alcohol, aliphatic ketone, alkyl acetate, or a combination thereof.

The viscosity of the homogenized electrode slurry is preferably about 8,000 mPa·s or less. In some embodiments, the viscosity of the homogenized electrode slurry is from about 1,000 mPa·s to about 8,000 mPa·s, from about 1,000 mPa·s to about 7,000 mPa·s, from about 1,000 mPa·s to about 6,000 mPa·s, from about 1,000 mPa·s to about 5,500 mPa·s, from about 1,000 mPa·s to about 5,000 mPa·s, from about 1,000 mPa·s to about 4,500 mPa·s, from about 1,000 mPa·s to about 4,000 mPa·s, from about 1,000 mPa·s to about 3,500 mPa·s, from about 1,000 mPa·s to about 3,000 mPa·s, from about 2,000 mPa·s to about 8,000 mPa·s, from about 2,000 mPa·s to about 7,000 mPa·s, from about 2,000 mPa·s to about 6,000 mPa·s, from about 2,000 mPa·s to about 5,500 mPa·s, from about 2,000 mPa·s to about 5,000 mPa·s, from about 2,000 mPa·s to about 4,500 mPa·s, from about 2,000 mPa·s to about 4,000 mPa·s, from about 3,000 mPa·s to about 8,000 mPa·s, from about 3,000 mPa·s to about 7,000 mPa·s, from about 3,000 mPa·s to about 6,500 mPa·s, from about 3,000 mPa·s to about 6,000 mPa·s, from about 3,000 mPa·s to about 5,500 mPa·s, from about 3,000 mPa·s to about 5,000 mPa·s, from about 3,500 mPa·s to about 8,000 mPa·s, from about 3,500 mPa·s to about 7,000 mPa·s, from about 3,500 mPa·s to about 6,500 mPa·s, from about 3,500 mPa·s to about 6,000 mPa·s, from about 3,500 mPa·s to about 5,500 mPa·s, from about 3,500 mPa·s to about 5,000 mPa·s, or from about 3,500 mPa·s to about 4,500 mPa·s.

In certain embodiments, the viscosity of the homogenized electrode slurry is about 8,000 mPa·s or less, about 7,500 mPa·s or less, about 7,000 mPa·s or less, about 6,500 mPa·s or less, about 6,000 mPa·s or less, about 5,500 mPa·s or less, about 5,000 mPa·s or less, about 4,500 mPa·s or less, about 4,000 mPa·s or less, about 3,500 mPa·s or less, about 3,000 mPa·s or less, about 2,500 mPa·s or less, or about 2,000 mPa·s or less. In some embodiments, the viscosity of the homogenized electrode slurry is about 1,000 mPa·s, about 1,500 mPa·s, about 2,000 mPa·s, about 2,500 mPa·s, about 3,000 mPa·s, about 3,500 mPa·s, about 4,000 mPa·s, about 4,500 mPa·s, about 5,000 mPa·s, about 5,500 mPa·s, about 6,000 mPa·s, about 6,500 mPa·s, about 7,000 mPa·s, about 7,500 mPa·s, or about 8,000 mPa·s. Thus, the resultant slurry can be fully mixed or homogeneous.

In conventional methods of preparing electrode slurries, a dispersing agent may be used to assist in dispersing the electrode active material, conductive agent and binder in the slurry. One of the advantages of the present invention is that the slurry components can be dispersed homogeneously at room temperature without the use of a dispersing agent. This is because the aqueous binder would be readily dispersed in the water-based slurry. In some embodiments, the method of the present invention does not comprise a step of adding a dispersing agent to one or more of the first suspension, second suspension, third suspension and the homogenized electrode slurry. In certain embodiments, each of the first suspension, the second suspension, the third suspension and the homogenized electrode slurry is independently free of a dispersing agent.

After uniform mixing of slurry components, the homogenized electrode slurry can be applied on a current collector to form a coated film on the current collector, followed by drying in step 104. The current collector acts to collect electrons generated by electrochemical reactions of the electrode active material or to supply electrons required for the electrochemical reactions. In some embodiments, the current collector can be in the form of a foil, sheet or film. In certain embodiments, the current collector is stainless steel, titanium, nickel, aluminum, copper, or alloys thereof. In other embodiments, the current collector is an electrically-conductive resin.

In certain embodiments, the current collector has a two-layered structure comprising an outer layer and an inner layer, wherein the outer layer comprises a conductive material and the inner layer comprises an insulating material or another conductive material; for example, aluminum mounted with a conductive resin layer or a polymeric insulating material coated with an aluminum film.

In some embodiments, the current collector has a three-layered structure comprising an outer layer, a middle layer and an inner layer, wherein the outer and inner layers comprise a conductive material and the middle layer comprises an insulating material or another conductive material; for example, a plastic substrate coated with a metal film on both sides. In certain embodiments, each of the outer layer, middle layer and inner layer is independently stainless steel, titanium, nickel, aluminum, copper, or alloys thereof or electrically-conductive resin. In some embodiments, the insulating material is a polymeric material selected from the group consisting of polycarbonate, polyacrylate, polyacrylonitrile, polyester, polyamide, polystyrene, polyurethane, polyepoxy, poly(acrylonitrile butadiene styrene), polyimide, polyolefin, polyethylene, polypropylene, polyphenylene sulfide, poly(vinyl ester), polyvinyl chloride, polyether, polyphenylene oxide, cellulose polymer and combinations thereof. In certain embodiments, the current collector has a structure with more than three layers. In some embodiments, the current collector is coated with a protective coating. In certain embodiments, the protective coating comprises a carbon-containing material. In some embodiments, the current collector is not coated with a protective coating.

In certain embodiments, the thickness of the electrode layer on the current collector is from about 5 μm to about 120 μm, from about 5 μm to about 100 μm, from about 5 μm to about 80 μm, from about 5 μm to about 50 μm, from about 5 μm to about 25 μm, from about 10 μm to about 90 μm, from about 10 μm to about 50 μm, from about 10 μm to about 30 μm, from about 15 μm to about 90 μm, from about 20 μm to about 90 μm, from about 25 μm to about 90 μm, from about 25 μm to about 80 μm, from about 25 μm to about 75 μm, from about 25 μm to about 50 μm, from about 30 μm to about 90 μm, from about 30 μm to about 80 μm, from about 35 μm to about 120 μm, from about 35 μm to about 115 μm, from about 35 μm to about 110 μm, from about 35 μm to about 105 μm, from about 35 μm to about 100 μm, from about 35 μm to about 95 μm, from about 35 μm to about 90 μm, from about 35 μm to about 85 μm, from about 35 μm to about 80 μm, from about 35 μm to about 75 μm, from about 40 μm to about 120 μm, from about 50 μm to about 120 μm, from about 60 μm to about 120 μm, from about 70 μm to about 120 μm, or from about 70 μm to about 115 μm.

In some embodiments, the thickness of the electrode layer on the current collector is about 5 μm or more, about 10 μm or more, about 15 μm or more, about 20 μm or more, about 25 μm or more, about 30 μm or more, about 35 μm or more, about 40 μm or more, about 45 μm or more, about 50 μm or more, about 55 μm or more, about 60 μm or more, about 65 μm or more, about 70 μm or more, about 75 μm or more, or about 80 μm or more. In some embodiments, the thickness of the electrode layer on the current collector is about 120 μm or less, about 115 μm or less, about 110 μm or less, about 105 μm or less, about 100 μm or less, about 95 μm or less, about 90 μm or less, about 85 μm or less, about 80 μm or less, about 75 μm or less, about 70 μm or less, about 65 μm or less, about 60 μm or less, about 55 μm or less, about 50 μm or less, about 45 μm or less, or about 40 μm or less. In some embodiments, the thickness of the electrode layer on the current collector is about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, or about 95 μm.

In some embodiments, the surface density of the electrode layer on the current collector is from about 1 mg/cm² to about 60 mg/cm², from about 1 mg/cm² to about 55 mg/cm², from about 1 mg/cm² to about 50 mg/cm², from about 1 mg/cm² to about 45 mg/cm², from about 1 mg/cm² to about 40 mg/cm², from about 1 mg/cm² to about 35 mg/cm², from about 1 mg/cm² to about 30 mg/cm², from about 1 mg/cm² to about 25 mg/cm², from about 10 mg/cm² to about 60 mg/cm², from about 10 mg/cm² to about 55 mg/cm², from about 10 mg/cm² to about 50 mg/cm², from about 10 mg/cm² to about 45 mg/cm², from about 10 mg/cm² to about 40 mg/cm², from about 10 mg/cm² to about 35 mg/cm², from about 10 mg/cm² to about 30 mg/cm², from about 10 mg/cm² to about 25 mg/cm², from about 20 mg/cm² to about 60 mg/cm², from about 20 mg/cm² to about 55 mg/cm², from about 20 mg/cm² to about 50 mg/cm², from about 20 mg/cm² to about 45 mg/cm², from about 20 mg/cm² to about 40 mg/cm², from about 25 mg/cm² to about 60 mg/cm², from about 25 mg/cm² to about 55 mg/cm², from about 25 mg/cm² to about 50 mg/cm², from about 25 mg/cm² to about 45 mg/cm², from about 25 mg/cm² to about 40 mg/cm², from about 28 mg/cm² to about 60 mg/cm², from about 28 mg/cm² to about 55 mg/cm², from about 28 mg/cm² to about 50 mg/cm², from about 28 mg/cm² to about 45 mg/cm², from about 28 mg/cm² to about 40 mg/cm², from about 30 mg/cm² to about 60 mg/cm², from about 30 mg/cm² to about 55 mg/cm², from about 30 mg/cm² to about 50 mg/cm², from about 30 mg/cm² to about 45 mg/cm², from about 30 mg/cm² to about 40 mg/cm², from about 35 mg/cm² to about 60 mg/cm², from about 35 mg/cm² to about 55 mg/cm², from about 35 mg/cm² to about 50 mg/cm², from about 35 mg/cm² to about 45 mg/cm², or from about 30 mg/cm² to about 40 mg/cm².

In some embodiments, the surface density of the electrode layer on the current collector is about 1 mg/cm² or above, about 10 mg/cm² or above, about 20 mg/cm² or above, about 25 mg/cm² or above, about 28 mg/cm² or above, about 30 mg/cm² or above, about 31 mg/cm² or above, about 32 mg/cm² or above, about 33 mg/cm² or above, about 34 mg/cm² or above, about 35 mg/cm² or above, about 36 mg/cm² or above, about 37 mg/cm² or above, about 38 mg/cm² or above, about 39 mg/cm² or above, or about 40 mg/cm² or above. In some embodiments, the surface density of the electrode layer on the current collector is about 60 mg/cm² or below, about 55 mg/cm² or below, about 50 mg/cm² or below, about 45 mg/cm² or below, about 44 mg/cm² or below, about 43 mg/cm² or below, about 42 mg/cm² or below, about 41 mg/cm² or below, about 40 mg/cm² or below, about 39 mg/cm² or below, about 38 mg/cm² or below, about 37 mg/cm² or below, about 36 mg/cm² or below, about 35 mg/cm² or below, about 34 mg/cm² or below, about 33 mg/cm² or below, about 32 mg/cm² or below, about 31 mg/cm² or below, or about 30 mg/cm² or below.

In some embodiments, a conductive layer can be coated on an aluminum current collector to improve its current conductivity. In certain embodiments, the conductive layer comprises a material selected from the group consisting of carbon, carbon black, graphite, expanded graphite, graphene, graphene nanoplatelets, carbon fibers, carbon nano-fibers, graphitized carbon flake, carbon tubes, carbon nanotubes, activated carbon, mesoporous carbon, and combinations thereof. In some embodiments, the conductive agent is not carbon, carbon black, graphite, expanded graphite, graphene, graphene nanoplatelets, carbon fibers, carbon nano-fibers, graphitized carbon flake, carbon tubes, carbon nanotubes, activated carbon, or mesoporous carbon.

In some embodiments, the conductive layer has a thickness from about 0.5 μm to about 5.0 μm. Thickness of the conductive layer will affect the volume occupied by the current collector within a battery and the amount of the electrode material and hence the capacity in the battery.

In certain embodiments, the thickness of the conductive layer on the current collector is from about 0.5 μm to about 4.5 μm, from about 1.0 μm to about 4.0 μm, from about 1.0 μm to about 3.5 μm, from about 1.0 μm to about 3.0 μm, from about 1.0 μm to about 2.5 μm, from about 1.0 μm to about 2.0 μm, from about 1.1 μm to about 2.0 μm, from about 1.2 μm to about 2.0 μm, from about 1.5 μm to about 2.0 μm, from about 1.8 μm to about 2.0 μm, from about 1.0 μm to about 1.8 μm, from about 1.2 μm to about 1.8 μm, from about 1.5 μm to about 1.8 μm, from about 1.0 μm to about 1.5 μm, or from about 1.2 μm to about 1.5 μm. In some embodiments, the thickness of the conductive layer on the current collector is less than 4.5 μm, less than 4.0 μm, less than 3.5 μm, less than 3.0 μm, less than 2.5 μm, less than 2.0 μm, less than 1.8 μm, less than 1.5 μm, or less than 1.2 μm. In some embodiments, the thickness of the conductive layer on the current collector is more than 1.0 μm, more than 1.2 μm, more than 1.5 inn, more than 1.8 inn, more than 2.0 μm, more than 2.5 μm, more than 3.0 μm, or more than 3.5 μm.

In addition, the electrode prepared by the present invention exhibits strong adhesion of the electrode layer to the current collector. It is important for the electrode layer to have good peeling strength to the current collector as this prevents delamination or separation of the electrode, which would greatly influence the mechanical stability of the electrodes and the cyclability of the battery. Therefore, the electrodes should have sufficient peeling strength to withstand the rigors of battery manufacture.

In some embodiments, the peeling strength between the current collector and the electrode layer is independently in the range from about 1.00 N/cm to about 7.00 N/cm, from about 1.25 N/cm to about 7.00 N/cm, from about 1.50 N/cm to about 7.00 N/cm, from about 1.75 N/cm to about 7.00 N/cm, from about 2.00 N/cm to about 7.00 N/cm, from about 2.25 N/cm to about 7.00 N/cm, from about 2.50 N/cm to about 7.00 N/cm, from about 2.75 N/cm to about 7.00 N/cm, from about 3.00 N/cm to about 7.00 N/cm, from about 3.00 N/cm to about 6.75 N/cm, from about 3.00 N/cm to about 6.50 N/cm, from about 3.00 N/cm to about 6.25 N/cm, from about 3.00 N/cm to about 6.00 N/cm, from about 3.00 N/cm to about 5.75 N/cm, from about 3.00 N/cm to about 5.50 N/cm, from about 3.00 N/cm to about 5.25 N/cm, or from about 3.00 N/cm to about 5.00 N/cm.

In some embodiments, the peeling strength between the current collector and the anode or cathode electrode layer is independently about 1.00 N/cm or above, about 1.25 N/cm or above, about 1.50 N/cm or above, about 1.75 N/cm or above, about 2.00 N/cm or above, about 2.25 N/cm or above, about 2.50 N/cm or above, about 2.75 N/cm or above, about 3.00 N/cm or above, about 3.25 N/cm or above, about 3.5 N/cm or above, about 3.75 N/cm or above, about 4.00 N/cm or above, about 4.25 N/cm or above, or about 4.50 N/cm or above. In some embodiments, the peeling strength between the current collector and the anode or cathode electrode layer is independently about 7.00 N/cm or below, about 6.75 N/cm or below, about 6.50 N/cm or below, about 6.25 N/cm or below, about 6.00 N/cm or below, about 5.75 N/cm or below, about 5.50 N/cm or below, about 5.25 N/cm or below, about 5.00 N/cm or below, about 4.75 N/cm or below, about 4.50 N/cm or below, about 4.25 N/cm or below, about 4.00 N/cm or below, about 3.75 N/cm or below, or about 3.50 N/cm or below.

The thickness of the current collector affects the volume it occupies within the battery, the amount of the electrode active material needed, and hence the capacity in the battery. In some embodiments, the current collector has a thickness from about 5 μm to about 30 μm. In certain embodiments, the current collector has a thickness from about 5 μm to about 20 μm, from about 5 μm to about 15 μm, from about 10 μm to about 30 μm, from about 10 μm to about 25 μm, or from about 10 μm to about 20 μm.

In some embodiments, the proportion of the additive in the electrode layer is from about 0.1% to about 5%, from about 0.2% to about 5%, from about 0.5% to about 5%, from about 0.8% to about 5%, from about 1% to about 5%, from about 1.2% to about 5%, from about 1.5% to about 5%, from about 1.8% to about 5%, from about 2% to about 5%, from about 2.2% to about 5%, from about 2.5% to about 5%, from about 0.1% to about 4.5%, from about 0.2% to about 4.5%, from about 0.5% to about 4.5%, from about 0.8% to about 4.5%, from about 1% to about 4.5%, from about 1.2% to about 4.5%, from about 1.5% to about 4.5%, from about 1.8% to about 4.5%, from about 2% to about 4.5%, from about 0.1% to about 4%, from about 0.2% to about 4%, from about 0.5% to about 4%, from about 0.8% to about 4%, from about 1% to about 4%, from about 1.2% to about 4%, from about 1.5% to about 4%, from about 1.8% to about 4%, from about 2% to about 4%, from about 0.1% to about 3.5%, from about 0.2% to about 3.5%, from about 0.5% to about 3.5%, from about 0.8% to about 3.5%, from about 1% to about 3.5%, from about 1.2% to about 3.5%, from about 1.5% to about 3.5%, from about 0.1% to about 3%, from about 0.2% to about 3%, from about 0.5% to about 3%, from about 0.8% to about 3%, from about 1% to about 3%, from about 0.5% to about 2%, or from about 0.5% to about 1.5% by weight, based on the total weight of the electrode layer.

In some embodiments, the proportion of the additive in the electrode layer is about 5% or less, about 4.5% or less, about 4% or less, about 3.5% or less, about 3% or less, about 2% or less, about 1.5% or less, about 1.4% or less, about 1.3% or less, about 1.2% or less, about 1.1% or less, about 1% or less, about 0.9% or less, about 0.8% or less, about 0.7% or less, about 0.6% or less, about 0.5% or less, about 0.4% or less, or about 0.3% or less by weight, based on total weight of the electrode layer. In some embodiments, the proportion of the additive in the electrode layer is about 0.1% or more, about 0.2% or more, about 0.3% or more, about 0.4% or more, about 0.5% or more, about 0.6% or more, about 0.7% or more, about 0.8% or more, about 0.9% or more, about 1% or more, about 1.1% or more, about 1.2% or more, about 1.3% or more, about 1.4% or more, about 1.5% or more, about 2% or more, about 2.5% or more, about 3% or more, or about 3.5% or more by weight, based on the total weight of the electrode layer.

In certain embodiments, the amount of the binder and the conductive agent in the electrode layer is each independently from about 0.5% to about 5%, from about 0.5% to about 4.5%, from about 0.5% to about 4%, from about 0.5% to about 3.5%, from about 0.5% to about 3%, from about 1% to about 5%, from about 1% to about 4.5%, from about 1% to about 4%, from about 1% to about 3.5%, from about 1.5% to about 5%, from about 1.5% to about 4.5%, or from about 2% to about 5% by weight, based on the total weight of the electrode layer. In some embodiments, the amount of the binder and the conductive agent in the electrode layer is each independently about 0.5% or more, about 1% or more, about 1.5% or more, about 2% or more, about 2.5% or more, about 3% or more, or about 3.5% or more by weight, based on the total weight of the electrode layer. In certain embodiments, the amount of the binder and conductive agent in the electrode layer is each independently about 5% or less, about 4.5% or less, about 4% or less, about 3.5% or less, or about 3% or less by weight, based on the total weight of the electrode layer.

In some embodiments, the amount of the electrode active material in the electrode layer is from about 40% to about 99%, from about 40% to about 95%, from about 40% to about 90%, from about 40% to about 85%, from about 40% to about 80%, from about 40% to about 75%, from about 40% to about 70%, from about 50% to about 99%, from about 50% to about 95%, from about 50% to about 90%, from about 50% to about 85%, from about 50% to about 80%, from about 50% to about 75%, from about 50% to about 70%, from about 60% to about 99%, from about 60% to about 95%, from about 60% to about 90%, from about 60% to about 85%, from about 60% to about 80%, from about 60% to about 75%, from about 70% to about 99%, from about 70% to about 95%, from about 70% to about 90%, from about 70% to about 85%, from about 75% to about 99%, from about 75% to about 95%, from about 75% to about 90%, from about 75% to about 85%, from about 80% to about 99%, from about 80% to about 95%, or from about 80% to about 90% by weight, based on the total weight of the of the electrode layer. In certain embodiments, the amount of the electrode active material in the electrode layer is about 40%, about 50%, about 60%, about 70%, about 75%, about 80%, about 85%, about 90%, about 93%, or about 95% by weight, based on the total weight of the of the electrode layer.

In certain embodiments, the amount of the electrode active material in the electrode layer is about 40% or more, about 45% or more, about 50% or more, about 55% or more, about 60% or more, about 65% or more, about 70% or more, about 75% or more, about 80% or more, about 85% or more, or about 90% or more by weight, based on the total weight of the of the electrode layer. In some embodiments, the amount of the electrode active material in the electrode layer is about 99% or less, about 95% or less, about 90% or less, about 85% or less, about 80% or less, about 75% or less, or about 70% or less by weight, based on the total weight of the of the electrode layer.

In certain embodiments, the coating process is performed using a doctor blade coater, a slot-die coater, a transfer coater, a spray coater, a roll coater, a gravure coater, a dip coater, or a curtain coater.

Evaporating the solvent to create a dry porous electrode is needed to fabricate the battery. After applying the homogenized electrode slurry on a current collector, the coated film on the current collector can be dried by a dryer to obtain the battery electrode. Any dryer that can dry the coated film on the current collector can be used herein. Some non-limiting examples of the dryer include a batch drying oven, a conveyor drying oven, and a microwave drying oven. Some non-limiting examples of the conveyor drying oven include a conveyor hot air drying oven, a conveyor resistance drying oven, a conveyor inductive drying oven, and a conveyor microwave drying oven.

In some embodiments, the conveyor drying oven for drying the coated film on the current collector includes one or more heating sections, wherein each of the heating sections is individually temperature-controlled, and wherein each of the heating sections may include independently controlled heating zones. In certain embodiments, each of the heating sections independently comprises one or more heating elements and a temperature control system connected to the heating elements in a manner to monitor and selectively control the temperature of each heating section.

In some embodiments, the coated film on the current collector can be dried at a temperature from about 25° C. to about 150° C. In certain embodiments, the coated film on the current collector can be dried at a temperature from about 25° C. to about 140° C., from about 25 ° C. to about 130° C., from about 25° C. to about 120° C., from about 25° C. to about 110° C., from about 25° C. to about 100° C., from about 25° C. to about 90° C., from about 25° C. to about 80° C., from about 25° C. to about 70° C., from about 30° C. to about 90° C., from about 30° C. to about 80 ° C., from about 30° C. to about 70° C., from about 40° C. to about 90° C., from about 40° C. to about 80° C., from about 40° C. to about 70° C., from about 50° C. to about 90° C., from about 50 ° C. to about 80° C., from about 60° C. to about 150° C., from about 60° C. to about 140° C., from about 60° C. to about 130° C., from about 60° C. to about 120° C., from about 60° C. to about 110 ° C., from about 60° C. to about 100° C., from about 60° C. to about 90° C., or from about 60° C. to about 80° C.

In some embodiments, the coated film on the current collector is dried at a temperature of about 150° C. or lower, about 140° C. or lower, about 130° C. or lower, about 120 ° C. or lower, about 110° C. or lower, about 100° C. or lower, about 90° C. or lower, about 80° C. or lower, or about 70° C. or lower. In some embodiments, the coated film on the current collector is dried at a temperature of about 100° C. or higher, about 90° C. or higher, about 80° C. or higher, about 70° C. or higher, about 60° C. or higher, about 50° C. or higher, about 40° C. or higher, about 30° C. or higher, or about 25° C. or higher.

In certain embodiments, the conveyor moves at a speed from about 1 meter/minute to about 120 meters/minute, from about 1 meter/minute to about 100 meters/minute, from about 1 meter/minute to about 50 meters/minute, from about 10 meters/minute to about 120 meters/minute, from about 10 meters/minute to about 100 meters/minute, from about 10 meters/minute to about 50 meters/minute, from about 25 meters/minute to about 120 meters/minute, from about 25 meters/minute to about 100 meters/minute, from about 25 meters/minute to about 50 meters/minute, from about 50 meters/minute to about 120 meters/minute, or from about 50 meters/minute to about 100 meters/minute.

Controlling the conveyor length and speed can regulate the drying time of the coated film. In some embodiments, the coated film on the current collector can be dried for a time period from about 1 minute to about 30 minutes, from about 2 minutes to about 30 minutes, from about 2 minutes to about 20 minutes, from about 2 minutes to about 10 minutes, from about 5 minutes to about 30 minutes, from about 5 minutes to about 20 minutes, from about 5 minutes to about 10 minutes, from about 10 minutes to about 30 minutes, or from about 10 minutes to about 20 minutes. In certain embodiments, the coated film on the current collector can be dried for a time period of less than 5 minutes, less than 10 minutes, less than 15 minutes, less than 20 minutes, or less than 30 minutes. In some embodiments, the coated film on the current collector can be dried for a time period of about 5 minutes, about 10 minutes, about 15 minutes, about 20 minutes, or about 30 minutes.

Since the electrode active materials are sufficiently active to react with water chemically, it is necessary to control the total processing time of the method 100. In some embodiments, the total processing time is from about 1 hours to about 8 hours, from about 2 hours to about 6 hours, or from about 2 hours to about 4 hours. In certain embodiments, the total processing time is about 8 hours or less, about 6 hours or less, about 4 hours or less, or about 3 hours or less.

After the coated film on the current collector is dried, an electrode is formed. In some embodiments, the electrode is compressed mechanically in order to enhance the density of the electrode.

The method disclosed herein has the advantage that aqueous solvents can be used in the manufacturing process, which can save on processing time and equipment, as well as improve safety by eliminating the need to handle or recycle hazardous organic solvents. In addition, costs are reduced by simplifying the overall process. Therefore, this method is especially suited for industrial processes because of its low cost and ease of handling.

The development of an aqueous binder for water-based electrode slurries improves slurry stability without lowering the battery performance such as cyclability and capacity. By adding the additive to the water-based electrode slurry, electrodes prepared in accordance with the present invention have superior flexibility even at high surface densities. Batteries comprising positive electrodes prepared in accordance with the present invention show high cycle stability. In addition, the low drying temperatures and decreased drying times of the coated film significantly improve performance of the batteries.

Also provided herein is an electrode assembly comprising an electrode prepared by the method described above. The electrode assembly comprises at least one cathode, at least one anode and at least one separator placed in between the cathode and anode.

In certain embodiments, the electrode assembly is dried after being assembled to reduce its water content. In other embodiments, at least one of the components of the electrode assembly is dried before the electrode assembly is assembled. In some embodiments, at least one of the components is pre-dried before assembly of the electrode assembly. In certain embodiments, the separator is pre-dried before being assembled to the electrode assembly.

It is not necessary to dry the separator to a very low water content. The remaining water content of the pre-dried separator can be further reduced by the subsequent drying step. In some embodiments, the water content in the pre-dried separator is from about 50 ppm to about 800 ppm, from about 50 ppm to about 700 ppm, from about 50 ppm to about 600 ppm, from about 50 ppm to about 500 ppm, from about 50 ppm to about 400 ppm, from about 50 ppm to about 300 ppm, from about 50 ppm to about 200 ppm, from about 50 ppm to about 100 ppm, from about 100 ppm to about 500 ppm, from about 100 ppm to about 400 ppm, from about 100 ppm to about 300 ppm, from about 100 ppm to about 200 ppm, from about 200 ppm to about 500 ppm, from about 200 ppm to about 400 ppm, from about 300 ppm to about 800 ppm, from about 300 ppm to about 600 ppm, from about 300 ppm to about 500 ppm, from about 300 ppm to about 400 ppm, from about 400 ppm to about 800 ppm, or from about 400 ppm to about 500 ppm by weight, based on the total weight of the pre-dried separator. In some embodiments, the water content in the pre-dried separator is less than 500 ppm, less than 400 ppm, less than 300 ppm, less than 200 ppm, less than 100 ppm, or less than 50 ppm by weight, based on the total weight of the pre-dried separator.

In certain embodiments, the dried electrode assembly may have a water content from about 20 ppm to about 350 ppm, from about 20 ppm to about 300 ppm, from about 20 ppm to about 250 ppm, from about 20 ppm to about 200 ppm, from about 20 ppm to about 100 ppm, from about 20 ppm to about 50 ppm, from about 50 ppm to about 350 ppm, from about 50 ppm to about 250 ppm, from about 50 ppm to about 150 ppm, from about 100 ppm to about 350 ppm, from about 100 ppm to about 300 ppm, from about 100 ppm to about 250 ppm, from about 100 ppm to about 200 ppm, from about 100 ppm to about 150 ppm, from about 150 ppm to about 350 ppm, from about 150 ppm to about 300 ppm, from about 150 ppm to about 250 ppm, from about 150 ppm to about 200 ppm, from about 200 ppm to about 350 ppm, from about 250 ppm to about 350 ppm, or from about 300 ppm to about 350 ppm by weight, based on the total weight of the dried electrode assembly.

The following examples are presented to exemplify embodiments of the invention but are not intended to limit the invention to the specific embodiments set forth. Unless indicated to the contrary, all parts and percentages are by weight. All numerical values are approximate. When numerical ranges are given, it should be understood that embodiments outside the stated ranges may still fall within the scope of the invention. Specific details described in each example should not be construed as necessary features of the invention.

### EXAMPLES

The pH value of the binder composition was measured at room temperature by an electrode-type pH meter (ION 2700, Eutech Instruments). The viscosity of slurry was measured at room temperature using a rotational viscosity meter (NDJ-5S, Shanghai JT Electronic Technology Co. Ltd., China) using rotor type no. 3 at a rotation speed of 12 rpm.

The peeling strengths of the dried electrode layers were measured by a tensile testing machine (DZ-106A, obtained from Dongguan Zonhow Test Equipment Co. Ltd., China). This test measures the average force required to peel an electrode layer from the current collector at 180° angle per 18 mm width of the test sample. A strip of adhesion tape (3M; US; model no. 810) with a width of 18 mm was attached onto the surface of the cathode electrode layer. The cathode strip was clipped onto the testing machine and the tape was folded back on itself at 180 degrees, and placed in a moveable jaw and pulled at room temperature and a peel rate of 200 mm per minute. The maximum stripping force measured was taken as the peeling strength. Measurements were repeated three times to find the average value.

The flexibility of the electrode was measured using specialized equipment involving fixed rods of various diameters or radii of curvature as specified by Chinese standard GB/T 1731-93, which determines the flexibility of films. The cathode strip, prepared using the electrode slurry coated onto aluminum foil, was dried in an electric blast drying oven at constant temperature for 15-30 minutes, then kept at a constant-temperature and constant-humidity environment for 30-60 minutes. This ensures that the cathode conforms to Chinese standard GB 1727-92 as specified for the flexibility test. The cathode strip was mechanically bent around a rod with constant force for 2-3 seconds, after which it was removed and inspected using a 4× microscope for imperfections such as exfoliation, cracking or fracture. The flexibility of the electrode was taken as the minimum diameter (or equivalent based on radius of curvature) of the rod to which the electrode can be bent in 0, the diameter in mm, without causing imperfections.

The water content in each of the electrode assembly and the separator was measured by Karl-Fischer titration. The electrode assembly or separator was cut into small pieces of 1 cm×1 cm in a glove box filled with argon gas. The cut electrode assembly or separator having a size of 1 cm×1 cm was weighed in a sample vial. The weighed electrode assembly or separator was then added into a titration vessel for Karl-Fischer titration using a Karl-Fischer coulometry moisture analyzer (831 KF Coulometer, Metrohm, Switzerland). Measurements were repeated three times to find the average value.

### Example 1

### A) Preparation of Binder Composition

18.15 g of sodium hydroxide (NaOH) was added into a round-bottom flask containing 380 g of distilled water. The mixture was stirred at 80 rpm for 30 mins to obtain a first binder synthesis suspension.

36.04 g of acrylic acid was added into the first suspension. The mixture was further stirred at 80 rpm for 30 mins to obtain a second binder synthesis suspension.

19.04 g of acrylamide was dissolved in 10 g of deionized (DI) water to form an acrylamide solution. Thereafter, all of the acrylamide solution was added into the second suspension. The mixture was further heated to 55° C. and stirred at 80 rpm for 45 mins to obtain a third binder synthesis suspension.

12.92 g of acrylonitrile was added into the third suspension. The mixture was further stirred at 80 rpm for 10 mins to obtain a fourth binder synthesis suspension.

Further, 0.015 g of water-soluble free radical initiator (ammonium persulfate, APS; obtained from Aladdin Industries Corporation, China) was dissolved in 3 g of DI water and 0.0075 g of reducing agent (sodium bisulfite; obtained from Tianjin Damao Chemical Reagent Factory, China) was dissolved in 1.5 g of DI water. All of the APS solution and all of the sodium bisulfite solution were added dropwise into the fourth suspension. The mixture was stirred at 200 rpm for 24 h at 55° C. to obtain a fifth binder synthesis suspension.

After the complete reaction, the temperature of the fifth binder synthesis suspension was lowered to 25° C. 3.72 g of NaOH was dissolved in 400 g of DI water. Thereafter, all of this sodium hydroxide solution was added slowly into the fifth binder synthesis suspension to adjust pH to 7.3 to form the sixth binder synthesis suspension. The sixth binder synthesis suspension was filtered using 200 μm nylon mesh to form the binder material. The solid content of the binder composition was 9.00 wt.%. The components of the binder composition of Example 1 and their respective proportions are shown in Table 1 below.

### B) Preparation of Positive Electrode

A first suspension was prepared by adding 0.158 g of an additive satisfying general formula (1), wherein the sum of w, x, y and z was 20 and the value of n was 10, and 7.50 g of the above binder composition to 16.9 g of deionized water while stirring with an overhead stirrer (R20, IKA). After the addition, the first suspension was further stirred for about 30 minutes at 25° C. at a speed of 1,200 rpm.

Thereafter, a second suspension was prepared by adding 0.675 g of conductive agent (Super P; obtained from Timcal Ltd, Bodio, Switzerland) into the first suspension. After the addition, the second suspension was further stirred for about 30 minutes at 25° C.

Thereafter, a third suspension was prepared by adding 21.0 g of LiFePO₄ (LFP; obtained from Shenzhen Dynanonic Co., Ltd., China) in the second suspension at 25° C. while stirring with an overhead stirrer. Then, the third suspension was degas sed under a pressure of about 10 kPa for 1 hour. Then, the third suspension was further stirred for about 60 minutes at 25° C. at a speed of 1,200 rpm to form a homogenized electrode slurry. The binder constituted 3 wt.% of the total weight of the solid content of the slurry. The particle size D50 of the LFP was 1 μm. The viscosity of the homogenized slurry was 4,040 mPa·s.

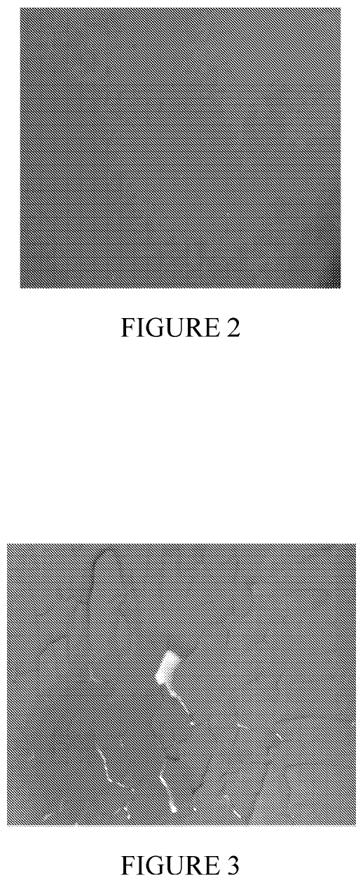

The homogenized electrode slurry was coated onto one side of an aluminum foil having a thickness of 16 μm as a current collector using a doctor blade coater with a gap width of 100 μm. The coated slurry film on the aluminum foil was dried to form a cathode electrode layer at 50° C. for about 6 minutes. The electrode was then pressed to decrease the thickness of the cathode electrode layer on the current collector to 85 μm. The flexibility and surface density of the cathode made using the slurry composition of Example 1 were measured and are shown in Table 2 below. A photograph of the dried coated slurry, taken shortly after the coating is fully dried on the current collector, can be found in FIG. 2. The peeling strength of the dried electrode layer was 4.57 N/cm.

### C) Preparation of Negative Electrode

A negative electrode slurry was prepared by mixing 92 wt.% of hard carbon (BTR New Energy Materials Inc., Shenzhen, Guangdong, China) with 1 wt.% carboxymethyl cellulose (CMC, BSH-12, DKS Co. Ltd., Japan) and 3 wt.% SBR (AL-2001, NIPPON A&L INC., Japan) as a binder, and 4 wt.% carbon black as a conductive agent in deionized water. The solid content of the anode slurry was 50 wt.%. The slurry was coated onto one side of a copper foil having a thickness of 8 μm using a doctor blade with a gap width of about 95 μm. The coated film on the copper foil was dried at about 50° C. for 2.4 minutes by a hot air dryer to obtain a negative electrode. The electrode was then pressed to decrease the thickness of the coating to 55 μm and the surface density was 17 mg/cm².

### D) Assembling of Coin Cell

CR2032 coin-type Li cells were assembled in an argon-filled glove box. The coated cathode and anode sheets were cut into disc-form positive and negative electrodes, which were then assembled into an electrode assembly by stacking the cathode and anode electrode plates alternatively and then packaged in a case made of stainless steel of the CR2032 type. The cathode and anode electrode plates were kept apart by separators. The separator was a ceramic coated microporous membrane made of polyethylene (Hebei Gellec New Energy Science & Technology Co., Ltd, China), which had a thickness of about 16 μm. The electrode assembly was then dried in a box-type resistance oven under vacuum (DZF-6020, obtained from Shenzhen Kejing Star Technology Co. Ltd., China) at 90° C. for about 16 hours. The water content of the separator and electrode assembly after drying was 200 ppm and 300 ppm respectively.

An electrolyte was then injected into the case holding the packed electrodes under a high-purity argon atmosphere with a moisture and oxygen content of less than 3 ppm respectively. The electrolyte was a solution of LiPF₆ (1 M) in a mixture of ethylene carbonate (EC), ethyl methyl carbonate (EMC) and dimethyl carbonate (DMC) at a volume ratio of 1:1:1. After electrolyte filling, the coin cell was vacuum sealed and then mechanically pressed using a punch tooling with a standard circular shape.

### E) Electrochemical Measurements

The coin cells were analyzed in a constant current mode using a multi-channel battery tester (BTS-4008-5V 10 mA, obtained from Neware Electronics Co. Ltd, China). After 1 cycle at C/20 was completed, they were charged and discharged at a rate of C/2. The charging/discharging cycling tests of the cells were performed between 2.0 and 3.65 V at a current density of C/2 at 25° C. to obtain the discharge capacity. The electrochemical performance of the coin cell of Example 1 was measured and is shown in Table 2 below.

Examples 2-3: A positive electrode was prepared in the same manner as in Example 1, except that the value of n of the additive was changed as shown in Table 1 below.

Examples 4-5: A positive electrode was prepared in the same manner as in Example 1, except that the amount of binder composition added into the first suspension was 7.46 g and 7.59 g respectively, and the amount of additive added into the first suspension was 0.045 g and 0.410 g respectively.

Examples 6-10: A positive electrode was prepared in the same manner as in Example 1, except that the binder composition was synthesized as described below to achieve the monomer proportions as shown in Table 1 below.

### Binder Composition of Example 6

The binder composition was prepared in the same manner as in Example 1, except that 28.70 g of NaOH was added in the preparation of the first binder synthesis suspension, 56.21 g of acrylic acid was added in the preparation of the second binder synthesis suspension, 4.27 g of acrylamide was added in the preparation of the third binder synthesis suspension and 8.49 g of acrylonitrile was added in the preparation of the fourth binder synthesis suspension.

### Binder Composition of Example 7

The binder composition was prepared in the same manner as in Example 1, except that 18.37 g of NaOH was added in the preparation of the first binder synthesis suspension, 36.44 g of acrylic acid was added in the preparation of the second binder synthesis suspension, 15.82 g of acrylamide was added in the preparation of the third binder synthesis suspension and 15.03 g of acrylonitrile was added in the preparation of the fourth binder synthesis suspension.

### Binder Composition of Example 8

The binder composition was prepared in the same manner as in Example 1, except that 16.93 g of NaOH was added in the preparation of the first binder synthesis suspension, 33.15 g of acrylic acid was added in the preparation of the second binder synthesis suspension, 23.46 g of acrylamide was added in the preparation of the third binder synthesis suspension and 11.14 g of acrylonitrile was added in the preparation of the fourth binder synthesis suspension.

Binder Composition of Example 9

The binder composition was prepared in the same manner as in Example 1, except that 11.78 g of NaOH was added in the preparation of the first binder synthesis suspension, 23.06 g of acrylic acid was added in the preparation of the second binder synthesis suspension, 6.40 g of acrylamide was added in the preparation of the third binder synthesis suspension and 31.31 g of acrylonitrile was added in the preparation of the fourth binder synthesis suspension.

### Binder Composition of Example 10

The binder composition was prepared in the same manner as in Example 1, except that 14.72 g of NaOH was added in the preparation of the first binder synthesis suspension, 28.82 g of acrylic acid was added in the preparation of the second binder synthesis suspension, 16.35 g of acrylamide was added in the preparation of the third binder synthesis suspension and 19.63 g of acrylonitrile was added in the preparation of the fourth binder synthesis suspension.

Comparative Example 1: A positive electrode was prepared in the same manner as in Example 1, except that the amount of binder composition and additive added to the first suspension was 7.45 g and 0 g respectively.

Comparative Examples 2-7: A positive electrode was prepared in the same manner as in Example 1, except that the binder composition was synthesized as described below to achieve the monomer proportions as shown in Table 1 below.

### Binder Composition of Comparative Example 2

The binder composition was prepared in the same manner as in Example 1, except that 7.45 g of NaOH was added in the preparation of the first binder synthesis suspension, 16.77 g of acrylic acid was added in the preparation of the second binder synthesis suspension, 7.19 g of acrylamide was added in the preparation of the third binder synthesis suspension and 35.95 g of acrylonitrile was added in the preparation of the fourth binder synthesis suspension.

### Binder Composition of Comparative Example 3

The binder composition was prepared in the same manner as in Example 1, except that 30.51 g of NaOH was added in the preparation of the first binder synthesis suspension, 58.31 g of acrylic acid was added in the preparation of the second binder synthesis suspension, acrylamide was not added in the preparation of the third binder synthesis suspension and 10.73 g of acrylonitrile was added in the preparation of the fourth binder synthesis suspension.

### Binder Composition of Comparative Example 4

The binder composition was prepared in the same manner as in Example 1, except that 24.44 g of NaOH was added in the preparation of the first binder synthesis suspension, 47.38 g of acrylic acid was added in the preparation of the second binder synthesis suspension, 25.16 g of acrylamide was added in the preparation of the third binder synthesis suspension and acrylonitrile was not added in the preparation of the fourth binder synthesis suspension.

### Binder Composition of Comparative Example 5

The binder composition was prepared in the same manner as in Example 1, except that 14.72 g of NaOH was added in the preparation of the first binder synthesis suspension, 28.83 g of acrylic acid was added in the preparation of the second binder synthesis suspension, 31.99 g of acrylamide was added in the preparation of the third binder synthesis suspension and 8.05 g of acrylonitrile was added in the preparation of the fourth binder synthesis suspension.

### Binder Composition of Comparative Example 6

The binder composition was prepared in the same manner as in Example 1, except that 11.28 g of NaOH was added in the preparation of the first binder synthesis suspension, 22.34 g of acrylic acid was added in the preparation of the second binder synthesis suspension, 3.56 g of acrylamide was added in the preparation of the third binder synthesis suspension and 33.96 g of acrylonitrile was added in the preparation of the fourth binder synthesis suspension.

A photograph of the dried coated slurry of the positive electrode of Comparative Example 6, taken shortly after the coating is fully dried on the current collector, can be found in FIG. 3.

### Binder Composition of Comparative Example 7

The binder composition was prepared in the same manner as in Example 1, except that 4.78 g of NaOH was added in the preparation of the first binder synthesis suspension, 9.37 g of acrylic acid was added in the preparation of the second binder synthesis suspension, 21.32 g of acrylamide was added in the preparation of the third binder synthesis suspension and 30.26 g of acrylonitrile was added in the preparation of the fourth binder synthesis suspension.

Comparative Example 8: A positive electrode was prepared in the same manner as in Example 1, except that the sum of w, x, y and z of the additive was 0.

Comparative Example 9: A positive electrode was prepared in the same manner as in Example 1, except that the additive does not satisfy general formula (1), but rather satisfies the following general formula (2):

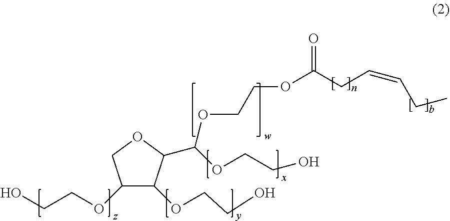

Note the carbon-carbon double bond in general formula (2). In Comparative Example 9, the sum of w, x, y and z was 20 and the values of a and b were both 7.

Comparative Examples 10-11: A positive electrode was prepared in the same manner as in Example 1, except that Triton™ X-100 (a nonionic surfactant) and triethyl citrate (an ionic surfactant) of the same weight were respectively used as the additive instead.

### Preparation of Negative Electrode of Examples 2-10 and Comparative Examples 1-11

The negative electrodes of Examples 2-10 and Comparative Examples 1-11 were prepared in the same manner as in Example 1.

### Assembling of Coin Cells of Examples 2-10 and Comparative Examples 1-11

The coin cells of Examples 2-10 and Comparative Examples 1-11 were assembled in the same manner as in Example 1.

### Electrochemical Measurements of Examples 2-10 and Comparative Examples 1-11

The electrochemical performance of the coin cells of Examples 2-10 and Comparative Examples 1-11 was measured in the same manner as in Example 1 and the test results are shown in Table 2 below.

While the invention has been described with respect to a limited number of embodiments, the specific features of one embodiment should not be attributed to other embodiments of the invention. In some embodiments, the methods may include numerous steps not mentioned herein. In other embodiments, the methods do not include, or are substantially free of, any steps not enumerated herein. Variations and modifications from the described embodiments exist. The appended claims intend to cover all those modifications and variations as falling within the scope of the invention.

TABLE 1

| | Binder composition | | | Additive | | |
|---|---|---|---|---|---|---|
| | Nitrile | Carboxylic acid | Amide | | | Proportion in slurry |
| | Proportion of the monomer | | | Value of | | (wt % of |
| Example | in copolymer (mol %) | | | w + x + y + z | Value of n | solid content) |
| Example 1 | 24 | 49.5 | 26.5 | 20 | 10 | 0.7 |
| Example 2 | 24 | 49.5 | 26.5 | 20 | 15 | 0.7 |
| Example 3 | 24 | 49.5 | 26.5 | 20 | 17 | 0.7 |
| Example 4 | 24 | 49.5 | 26.5 | 20 | 10 | 0.2 |
| Example 5 | 24 | 49.5 | 26.5 | 20 | 10 | 1.8 |
| Example 6 | 16 | 78 | 6 | 20 | 10 | 0.7 |
| Example 7 | 28 | 50 | 22 | 20 | 10 | 0.7 |
| Example 8 | 21 | 46 | 33 | 20 | 10 | 0.7 |
| Example 9 | 59 | 32 | 9 | 20 | 10 | 0.7 |
| Example 10 | 37 | 40 | 23 | 20 | 10 | 0.7 |
| Comparative Example 1 | 24 | 49.5 | 26.5 | — | | |
| Comparative Example 2 | 67 | 23 | 10 | 20 | 10 | 0.7 |
| Comparative Example 3 | 20 | 80 | 0 | 20 | 10 | 0.7 |
| Comparative Example 4 | 0 | 65 | 35 | 20 | 10 | 0.7 |
| Comparative Example 5 | 15 | 40 | 45 | 20 | 10 | 0.7 |
| Comparative Example 6 | 64 | 31 | 5 | 20 | 10 | 0.7 |
| Comparative Example 7 | 57 | 13 | 30 | 20 | 10 | 0.7 |
| Comparative Example 8 | 24 | 49.5 | 26.5 | 0 | 10 | 0.7 |

| | | | | | |
|---|---|---|---|---|---|
| Comparative Example 9 | 24 | 49.5 | 26.5 | Formula (2) | 0.7 |
| Comparative Example 10 | 24 | 49.5 | 26.5 | Triton X-100 | 0.7 |
| Comparative Example 11 | 24 | 49.5 | 26.5 | Triethyl citrate | 0.7 |

TABLE 2

| | Electrode performance | | Cell performance | |
|---|---|---|---|---|
| | | | 0.5C Initial | |
| | | Surface | discharging | Capacity |
| | Electrode | density | capacity | retention after |
| Example | flexibility | (mg/cm²) | (mAh/g) | 50 cycles (%) |
| Example 1 | Φ1.0 | 38 | 131.3 | 93.6 |
| Example 2 | Φ1.5 | 38 | 131.1 | 91.9 |
| Example 3 | Φ1.5 | 38 | 130.3 | 92.1 |
| Example 4 | Φ1.0 | 38 | 129.1 | 91.1 |
| Example 5 | Φ1.0 | 38 | 129.9 | 92.6 |
| Example 6 | Φ1.0 | 38 | 131.2 | 91.9 |
| Example 7 | Φ1.0 | 38 | 131.7 | 92.3 |
| Example 8 | Φ1.0 | 38 | 130.2 | 90.7 |
| Example 9 | Φ1.0 | 38 | 131.1 | 91.3 |
| Example 10 | Φ1.0 | 38 | 130.8 | 91.4 |

| Comparative | Φ3.0 | 32 | — |
|---|---|---|---|
| Example 1* | | | |
| Comparative | — | | — |
| Example 2*^{#} | | | |
| Comparative | — | | — |
| Example 3*^{#} | | | |
| Comparative | — | | — |
| Example 4*^{#} | | | |
| Comparative | — | | — |
| Example 5*^{#} | | | |
| Comparative | — | | — |
| Example 6*^{#} | | | |
| Comparative | — | | — |
| Example 7*^{#} | | | |
| Comparative | Φ3.0 | 38 | — |
| Example 8* | | | |
| Comparative | Φ3.0 | 38 | — |
| Example 9* | | | |
| Comparative | Φ3.0 | 38 | — |
| Example 10* | | | |
| Comparative | Φ3.0 | 38 | — |
| Example 11* | | | |

*Did not produce a testable cell due to insufficient electrode flexibility.
^{#}Did not produce a testable electrode.

What is claimed is:

1. An electrode for a secondary battery, comprising a current collector and an electrode layer coated on one or more surfaces of the current collector, wherein the electrode layer comprises an electrode active material, a binder and an additive, wherein the additive satisfies general formula (1).

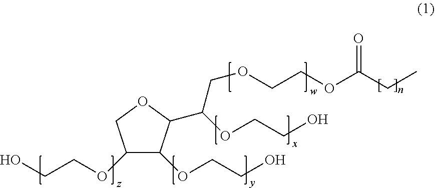

2. The electrode of claim 1, wherein n is from about 5 to about 25.

3. The electrode of claim 1, wherein the sum of w, x, y and z is from about 10 to about 80.

4. The electrode of claim 1, wherein the additive has a hydrophile-lipophile balance number from about 12 to about 18.

5. The electrode of claim 1, wherein the thickness of the electrode layer on the current collector is from about 5 μm to about 120 μm, and wherein the surface density of the electrode layer on the current collector is from about 1 mg/cm² to about 60 mg/cm².

6. The electrode of claim 1, wherein the electrode active material is a cathode active material selected from the group consisting of Li₁₊ₓNiₐMn_{b}Co_{c}Al_{(1-a-b-c)}O₂, LiNi_{0.33}Mn_{0.33}Co_{0.33}O₂, LiNi_{0.4}Mn_{0.4}Co_{0.2}O₂, LiNi_{0.5}Mn_{0.3}Co_{0.2}O₂, LiNi_{0.6}Mn_{0.2}Co_{0.2}O₂, LiNi_{0.7}Mn_{0.15}Co_{0.15}O₂, LiNi_{0.7}Mn_{0.1}Co_{0.2}O₂, LiNi_{0.8}Mn_{0.1}Co_{0.1}O₂. LiNi_{0.92}Mn_{0.04}Co_{0.04}O₂, LiNi_{0.8}Co_{0.15}Al_{0.05}O₂, LiCoO₂, LiNiO₂, LiMnO₂, LiMn₂O₄, Li₂MnO₃, LiFePO₄, LiCoPO₄, LiNiPO₄, LiMnPO₄, LiMnFePO₄, LiMndFe_{(1-d)}PO₄, dLi₂MnO₃·(1−d)LiMO₂, LiNiₑMn_{f}O₄, Li₃V₂(PO₄)₃, LiVPO₄F, Li₂MSiO₄ and combinations thereof; wherein −0.2≤x≤0.2, 0≤a<1, 0≤b<1, 0≤c<1, a+b+c≤1, 0<d<1, 0.1≤e≤0.9, 0≤f≤2 and M is selected from the group consisting of Fe, Co, Mn, Ni, and combinations thereof.

7. The electrode of claim 1, wherein the electrode active material is a cathode active material that comprises or is a core-shell composite comprising a core and a shell, wherein the core and the shell independently comprises a lithium transition metal oxide selected from the group consisting of Li₁₊ₓNiₐMn_{b}Co_{c}Al_{(1-a-b-c)}O₂, LiCoO₂, LiNiO₂, LiMnO₂, LiMn₂O₄, Li₂MnO₃, LiFePO₄, LiCrO₂, Li₄Ti₅O₁₂, LiV₂O₅, LiTiS₂, LiMoS₂, LiCoₐNi_{b}O₂, LiMnₐNi_{b}O₂, and combinations thereof, wherein −0.2≤x≤0.2, 0≤a<1, 0≤b<1, 0≤c≤1, and a+b+c≤1.

8. The electrode of claim 1, wherein the electrode active material is an anode active material selected from the group consisting of natural graphite particulate, synthetic graphite particulate, Sn (tin) particulate, Li₄Ti₅O₁₂ particulate, Si (silicon) particulate, Si—C composite particulate, and combinations thereof.

9. The electrode of claim 1, wherein the binder comprises a copolymer, wherein said copolymer comprises one or more hydrophilic structural units, and one or more hydrophobic structural units.

10. The electrode of claim 9, wherein the hydrophilic structural units are derived from monomers comprising the group consisting of a carboxylic acid-containing monomer, an amide-containing monomer and combinations thereof; wherein the carboxylic acid-containing monomer is in the form of a carboxylic acid, a carboxylic acid salt, a carboxylic acid derivative or a combination thereof; and wherein the proportion of the hydrophilic structural units in the binder is from about 10% to about 90% by mole, based on the total number of moles of monomeric units in the binder.

11. The electrode of claim 9, wherein the hydrophobic structural units are derived from monomers comprising a nitrile-containing monomer, and wherein the proportion of the hydrophobic structural units in the binder is from about 10% to about 90% by mole, based on the total number of moles of monomeric units in the binder.

12. The electrode of claim 1, further comprising a conductive agent that is selected from the group consisting of carbon, carbon black, graphite, expanded graphite, graphene, graphene nanoplatelets, carbon fibers, carbon nano-fibers, graphitized carbon flake, carbon tubes, carbon nanotubes, activated carbon, mesoporous carbon and combinations thereof.

13. The electrode of claim 1, wherein the proportion of the additive in the electrode layer is from about 0.1% to about 5% by weight, based on the total weight of the electrode layer.

14. The electrode of claim 1, wherein the amount of the binder and the conductive agent in the electrode layer is independently from about 0.5% to about 5% by weight, based on the total weight of the electrode layer.

15. An electrode slurry for a secondary battery, comprising an electrode active material, a binder, an additive and a solvent, wherein the additive satisfies general formula (1).

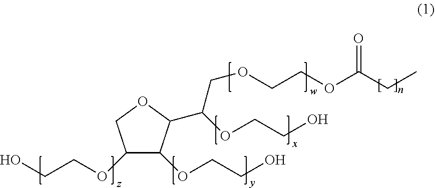

16. The electrode slurry of claim 15, wherein the solvent is water.

17. The electrode slurry of claim 15, wherein the proportion of the additive in the electrode slurry is from about 0.1% to about 5% by weight, based on the total weight of the solid content of the electrode slurry.

18. The electrode slurry of claim 15, wherein the amount of the electrode active material in the electrode slurry is from about 20% to about 80% by weight, based on the total weight of the electrode slurry.

19. A secondary battery comprising the electrode of claim 1.
